(19) United States
(12) Patent Application Publication
(10) Pub. No.: US 2022/0343354 A1
(43) Pub. Date: Oct. 27, 2022

(54) SYSTEMS, METHODS, AND GRAPHICAL USER INTERFACES FOR PRICE BOOK GENERATION, MODIFICATION, AND VISUALIZATION

(71) Applicant: PricewaterhouseCoopers LLP, New York, NY (US)

(72) Inventors: Amit DHIR, San Jose, CA (US); Giridhar SRINIVASA, Bangalore (IN)

(73) Assignee: PricewaterhouseCoopers LLP, New York, NY (US)

(21) Appl. No.: 17/579,273

(22) Filed: Jan. 19, 2022

Related U.S. Application Data
(60) Provisional application No. 63/180,624, filed on Apr. 27, 2021.

(51) Int. Cl. G06Q 30/02

(52) U.S. Cl. CPC G06Q 30/0205

(57) ABSTRACT

Systems, methods, and graphical user interfaces (GUIs) for visualizing price-book data are provided. Product identifiers and associated price data points are ingested from a plurality of sources and stored in accordance with a product hierarchy. The product identifiers are furthermore organized into a plurality of price books that have a nested relationship with one another. A GUI is provided by which a user may execute an instruction to visualize a portion of the stored data, wherein the input comprises an indication of a subset of the plurality of product identifiers comprising an indication of one or more of the price books. In response to detecting the input, the system generates and displays a visualization based at least in part on the input. Users may further use the GUI to modify one or more price data points in a price book, including simultaneously modifying price data points across multiple price books.

### CROSS-REFERENCE TO RELATED APPLICATIONS

This application claims the benefit of U.S. Provisional Application No. 63/180,624, filed Apr. 27, 2021, the entire contents of which are incorporated herein by reference.

### FIELD

This disclosure relates generally to systems and methods for automated data set processing and visualization, and more specifically to systems and methods for managing list prices by ingesting data from one or more data sources, processing the ingested data to generate one or more price books, and displaying visualizations of data included in the one or more price books.

### BACKGROUND

An analyst may rely on data and/or intuition and experience to make important decisions. For example, in a business context, a salesperson may generate a quote for a stock-keeping unit (herein after referred to as an “SKU”) based on data and/or intuition. However, currently, there is no way to ensure that the analyst has access to a robust data set, such that the analyst can accurately and efficiently make data-driven decisions. For example, many organizations struggle to manage prices globally. Organizational data including price data, geographic area data, and/or product group data for SKUs may be scattered across many different data sources (e.g., databases), each of which may include incomplete, unstructured, and/or inconsistent data. Processing the data to standardize, cleanse, and/or aggregate the data via data sources that include incomplete, unstructured, and/or inconsistent data may be very costly and time-consuming. Moreover, processing the data via data sources that include incomplete, unstructured, and/or inconsistent data may be difficult to perform systematically, and may instead need to be performed manually. Such manual processing may result in reduced data security, inefficiencies, and/or errors.

However, if data is not processed, insights that may be generated from the data may be limited. For example, when compared to aggregated data, non-aggregated data may include fewer variables associated with an SKU sold by the organization (e.g., non-aggregated data may only include price data for the SKU, whereas aggregated data may include price data, geographic area data, and product family data for the SKU). Moreover, when compared to aggregated data, non-aggregated data may include a more limited set of SKUs which may be compared to one another (e.g., non-aggregated data may only include price data for one or more SKUs associated with a region, whereas aggregated data may include price data for one or more SKUs associated with multiple regions, and/or price data for SKUs associated with multiple countries and/or local municipalities within one or more regions).

When faced with inefficient and/or impractical options to make data-driven decisions, a businessperson may instead turn to making decisions based on intuition and/or experience. However, making decisions based on intuition and/or experience may lead to inefficient, inconsistent and/or incomplete decision-making. Such decision-making may lead to margin/revenue leakage, inconsistent prices in the market, longer deal cycle times, unmet sales targets, low customer satisfaction, and/or customer churn. For example, margin leakage may occur if a salesperson quotes a price that is below an economically viable margin. Additionally, such decision-making may lead to an inability to predict customer preferences regarding product prices, volumes, and/or distribution channels.

In a business context, data-driven decision making is highly valuable. As markets around the world have become more interconnected and market demands become more complex, advanced analytical techniques have become more important.

### SUMMARY

In consideration of the above, there is a need for systems and methods that effectively and efficiently consolidate data included in multiple data sources and enable a user to generate a wide array of data insights based on the consolidated data. Furthermore, there is a need for systems and methods that present insights to users based on the consolidated data, where the insights are generated, selected, and presented based at least in part on levels of authority of the user and on the relationship between the user (and the user's associated authority level) to the consolidated data sets.

Accordingly, disclosed herein are systems, methods, and graphical user interfaces for generating one or more price books that include consolidated data and displaying one or more visualizations of data included in the one or more price books. In some embodiments, the techniques disclosed herein may enable systems and users to manage one or more price lists. The one or more price books may be generated by processing one or more ingested data sets. For example, two or more ingested data sets may be aggregated to consolidate data included in various sources, thereby creating an aggregated data set. Entities included in one, some, or all of the ingested data sets may be organized (e.g., in a hierarchy, in which a first group is nested within a second group), such that entities included in the aggregated data set are organized. The entities included in the aggregated data set may be organized into a plurality of price books, each of which may include data for a respective set of attributes (e.g., revenue, discount percentage, and/or margin) for each of a respective set of entities (e.g., SKUs).

One or more of the plurality of price books may be viewed in real-time and/or one or more new price books may be created in real-time. Each price book may be associated with a geographic area. For example, a price book may be associated with a region (which may alternatively be referred to as a “geo”) such as “Americas,” a country such as the United States of America, and/or a local municipality (which may alternatively be referred to as a “locality”) such as New York. One or more of the plurality of price books may be flexibly customized in real-time to quantify an impact of a modification. For example, a salesperson may manage list prices by modifying a price of an SKU to quantify a change in margin. Thus, a salesperson may be able to rapidly and accurately quantify an impact a modification has for one or more SKUs of interest. One or more of the plurality of price books may be associated with one or more approvers, such that a modification may be approved by an approver before being implemented. For example, a price book may have built-in rules pertaining to acceptable price ranges for an SKU, and deviating from an acceptable price range (e.g., in response to a price modification made by a salesperson) may automatically trigger soliciting approval for a price from an approver who is associated with an appropriate override credential (e.g., a manager). The salesperson may then decide whether to implement a modification based on the quantified impact and/or managerial approval.

A subset of attributes for a subset of SKUs included in one or more of the price books may be displayed, thus enabling a user to flexibly and rapidly make data-driven decisions. Displaying the subset of attributes for the subset of SKUs may facilitate comparison among price books (e.g., such that for an SKU, a price in one price book may be compared to a price in another price book, and/or such that for a price book, one SKU may be compared to another).

Thus, by generating one or more price books, and by displaying data included in one or more price books, the systems, methods, and graphical user interfaces described herein may be used to efficiently and effectively make data-driven decisions.

In some embodiments, a system for visualizing price-book data is provided, the system comprising: a database storing data representing a plurality of product identifiers and associated price data points for respective product identifiers of the plurality of product identifiers, wherein: the plurality of product identifiers and associated price data points are ingested from a plurality of sources; the plurality of product identifiers are stored in accordance with product hierarchy data that organizes the product identifiers into a plurality of product groups, wherein a first product group of the plurality of product groups is nested within a second product group of the plurality of product groups; and the plurality of product identifiers are organized into a plurality of price books, wherein each price book of the plurality of price books is associated with a respective geographic area of a plurality of geographic areas, wherein a first geographic area of the plurality of geographic areas is nested within a second geographic area of the plurality of geographic areas; one or more processors; and a memory storing one or more programs, the one or more programs configured to be executed by the one or more processors to cause the system to: cause display of a graphical user interface comprising a visualization portion and an input portion; detect a visualization input executed via the input portion of the graphical user interface, wherein the visualization input comprises an indication of a subset of the plurality of product identifiers, wherein the indication of the subset of the plurality of product identifiers comprises an indication of one or more of the price books; generate a visualization based at least in part on the data and the visualization input; and cause display of the visualization in the visualization portion.

In some embodiments, the data representing the plurality of product identifiers is associated with one or more price data points for each product identifier of the plurality of product identifiers; and each price book of the plurality of price books indicates, for each respective product identifier in the price book, a respective price data point of the one or more price data points for the respective product identifier.

In some embodiments, the one or more programs are further configured to cause the system to: receive raw data comprising product hierarchy data, geographic hierarchy data, and raw pricing data; and process the raw data to generate the plurality of price books.

In some embodiments: the product hierarchy data is received from a product hierarchy data source, the geographic hierarchy data is received from a geographic hierarchy data source, and the raw pricing data is received from a pricing data source; and processing the raw data comprises: aggregating the product hierarchy data, the geographic hierarchy data, and the raw pricing data to generate the data representing a plurality of product identifiers and associated price data points; and for each of the plurality of price books, filtering the plurality of product identifiers included in the data representing a plurality of product identifiers to select a subset of the plurality of product identifiers for inclusion in the price book.

In some embodiments, the one or more programs are further configured to cause the system to: receive a price-book modification input executed via the input portion of the graphical user interface; and in response to receiving the price-book modification input, modify one or more of the plurality of price books, wherein modifying one or more of the plurality of price books comprises adjusting a price data point for a product identifier in the one or more price books.

In some embodiments, modifying the one or more of the plurality of price books comprises manually adjusting a price data point for the product identifier to a user-specified price.

In some embodiments, modifying the one or more of the plurality of price books comprises simultaneously modifying a plurality of price data points for a plurality of respective product identifiers in an indicated price book of the one or more price books, wherein modification comprises one or more modifications selected from the group of: applying a price book adjustment percentage, wherein applying the price book adjustment percentage comprises modifying respective price data points for a plurality of respective product identifiers by an indicated percentage; applying a cost preservation, wherein applying the cost preservation comprises modifying respective price data points for a plurality of respective product identifiers such that the price data points are, at minimum, equal to a respective cost to manufacture the product identifier; applying a cost preservation buffer, wherein applying the cost preservation buffer comprises modifying respective data points for a plurality of respective product identifiers such that the price data points exceed a respective cost to manufacture the product identifier by an indicated percentage; and applying a min/max pricing scheme, wherein applying the min/max pricing scheme comprises modifying respective price data points of respective product identifiers such that the price data points fall within a specified min/max envelope.

In some embodiments, modifying the one or more of the plurality of price books comprises simultaneously modifying one or more price data points for one or more respective product identifiers across multiple price books, wherein the modification input comprises an indication of the multiple price books comprising an indication of a geographic area.

In some embodiments, the one or more programs are further configured to: in response to receiving the price-book modification input: determine a set of one or more of the plurality of price books for which approval for the modification input is required, wherein the determination is based at least in part on one or more approval thresholds for adjusting the price data point for the product identifier; and cause display of an indication of the one or more of the plurality of price books for which approval is required.

In some embodiments, the one or more programs are further configured to cause the system to: receive a price-book creation input executed via the input portion of the graphical user interface, wherein the price-book creation input comprises an indication of a set of product identifiers for a new price book; and in response to receiving the price-book creation input, create the new price book in the data based at least in part on the indication of the set of product identifiers.

In some embodiments, the indication of the set of product identifiers for the new price book comprises an indication of one or more product groups of the plurality of product groups.

In some embodiments: the price-book creation input comprises an indication of a set of attributes for one or more product identifiers of the set of product identifiers for the new price book, and creating the new price book in the data is based at least in part on the indication of the set of attributes for the one or more product identifiers of the set of product identifiers for the new price book.

In some embodiments, the indication of the set of product identifiers for the new price book comprises an indication of a preexisting price book, wherein the set of product identifiers is a subset of product identifiers from the preexisting price book.

In some embodiments: each product identifier of the plurality of product identifiers is stored in association with a respective set of attributes; the visualization input comprises an indication of a subset of attributes in addition to the indication of the subset of the plurality of product identifiers; and the visualization comprises a graph displaying the subset of attributes for the subset of product identifiers.

In some embodiments, the visualization simultaneously comprises a plurality of graphs, wherein a first graph of the plurality of graphs displays a first subset of attributes for a first subset of product identifiers, and wherein a second graph of the plurality of graphs displays a second subset of attributes for a second subset of product identifiers.

In some embodiments, method for visualizing price-book data is provided, the method performed at a system comprising one or more processors and a database storing data representing a plurality of product identifiers and associated price data points for respective product identifiers of the plurality of product identifiers, wherein: the plurality of product identifiers and associated price data points are ingested from a plurality of sources; the plurality of product identifiers are stored in accordance with product hierarchy data that organizes the product identifiers into a plurality of product groups, wherein a first product group of the plurality of product groups is nested within a second product group of the plurality of product groups; and the plurality of product identifiers are organized into a plurality of price books, wherein each price book of the plurality of price books is associated with a respective geographic area of a plurality of geographic areas, wherein a first geographic area of the plurality of geographic areas is nested within a second geographic area of the plurality of geographic areas; the method comprising: causing display of a graphical user interface comprising a visualization portion and an input portion; detecting a visualization input executed via the input portion of the graphical user interface, wherein the visualization input comprises an indication of a subset of the plurality of product identifiers, wherein the indication of the subset of the plurality of product identifiers comprises an indication of one or more of the price books; generating a visualization based at least in part on the data and the visualization input; and causing display of the visualization in the visualization portion.

In some embodiments, a non-transitory computer-readable storage medium for visualizing price-book data is provided, the non-transitory computer-readable storage medium storing instructions configured to be executed by one or more processors of a system comprising a database storing data representing a plurality of product identifiers and associated price data points for respective product identifiers of the plurality of product identifiers, wherein: the plurality of product identifiers and associated price data points are ingested from a plurality of sources; the plurality of product identifiers are stored in accordance with product hierarchy data that organizes the product identifiers into a plurality of product groups, wherein a first product group of the plurality of product groups is nested within a second product group of the plurality of product groups; and the plurality of product identifiers are organized into a plurality of price books, wherein each price book of the plurality of price books is associated with a respective geographic area of a plurality of geographic areas, wherein a first geographic area of the plurality of geographic areas is nested within a second geographic area of the plurality of geographic areas; wherein execution of the instructions by the one or more processors causes the system to: cause display of a graphical user interface comprising a visualization portion and an input portion; detect a visualization input executed via the input portion of the graphical user interface, wherein the visualization input comprises an indication of a subset of the plurality of product identifiers, wherein the indication of the subset of the plurality of product identifiers comprises an indication of one or more of the price books; generate a visualization based at least in part on the data and the visualization input; and cause display of the visualization in the visualization portion.

In some embodiments, any one or more of the features or aspects of the embodiments received below may be combined in whole or in part with one another, and/or may be combined in whole or in part with any other feature or aspect disclosed herein.

### BRIEF DESCRIPTION OF THE DRAWINGS

Various embodiments are described with reference to the accompanying figures, in which:

FIG. 1 depicts a system architecture of an automated data set processing and visualization system, according to some embodiments;

FIGS. 2A-2B depict flowcharts of a method for using an automated data set processing and visualization system, according to some embodiments;

FIGS. 3A-3B, 4A-4J, 5A-5C, 6A-6C, and 7 show graphical user interfaces for visualizing data generated from an automated data set processing and visualization system, according to some embodiments; and

FIG. 8 illustrates a computing device, according to some embodiments.

### DETAILED DESCRIPTION

Described herein are automated data set processing and visualization systems and methods. In particular, provided herein are systems and methods for ingesting data from one or more data sources, processing the ingested data to generate one or more price books, and displaying a visualization of data included in the one or more price books. Systems and methods provided herein may enable users to more efficiently, more accurately, and/or more precisely analyze and generate data-driven decisions pertaining to complex data sets. Systems and methods disclosed herein may enable users to manage list prices effectively. The systems, methods, and techniques disclosed herein may address the problems and shortcoming of known systems as described above.

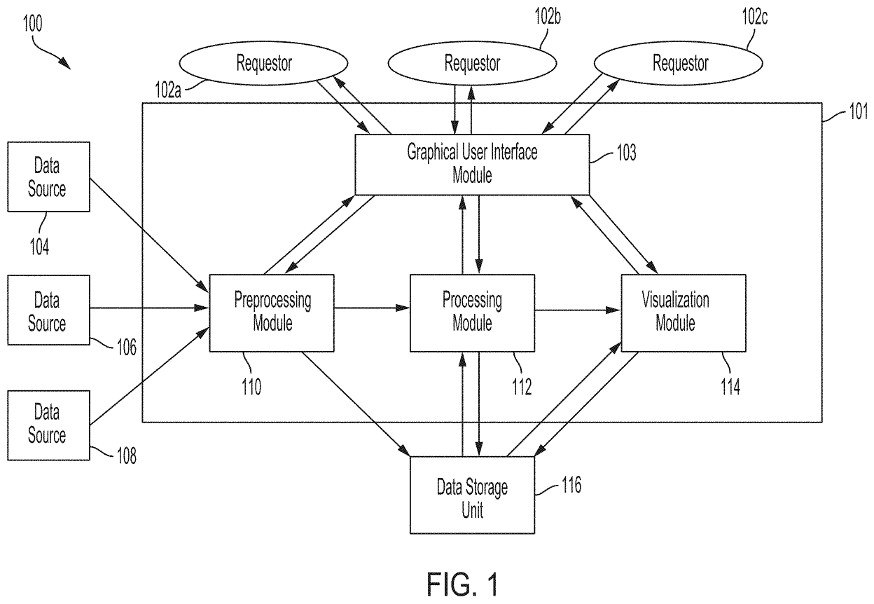

FIG. 1 depicts an automated data set processing and visualization system 100, according to some embodiments. Automated data set processing and analysis system 100 may comprise data set processing and visualization tool 101 that can comprise any computer, processor, server, etc. that is configured to execute a method of data set processing and visualization as described herein. Data set processing and visualization tool 101 may comprise graphical user interface module 103, preprocessing module 110, processing module 112, and visualization module 114, as described further below. The graphical user interface module 103, preprocessing module 110, processing module 112, and visualization module 114 may be provided by the same computer, processor, or server; additionally or alternatively, one or more of said modules may be provided by a different computer, processor, or server (e.g., tool 101 and/or system 100 may be provided in whole or in part as a server-hosted computing system, a distributed computing system, and/or a cloud-based computing system).

In some embodiments, data set aggregation and analysis tool 101 may be provided via a cloud-based web-application. The web-application may advantageously enable a user to more securely and/or more quickly ingest data, provide one or more user inputs, and visualize data in accordance with the one or more user inputs. The web-application may enhance security by including BYOK, role-based access control, user management, SSO support (e.g., with SAML 2.0 compliance), and/or data encryption at rest and in transit. The web-application may leverage a number of pre-built and/or custom scripts and a graphical user interface that enable a user to ingest data from various sources (e.g., from data sources at various levels, such as strategic and/or operational levels), manage the ingested data in real time (e.g., via one or more user inputs to the graphical user interface), build more accurate models to analyze the ingested data, and/or visualize data in a user-friendly manner.

In some embodiments, automated data set processing and visualization system 100 can include requestor 102a, requestor 102b, and/or requestor 102c (each of which may be (or include) a user device and/or user system), first data source 104, second data source 106, third data source 108, and/or data storage unit 116, each of which may be communicatively coupled (e.g., by wired or wireless network communication) with data set processing and visualization tool 101. In some embodiments, requestor 102a, requestor 102b, requestor 102c, first data source 104, second data source 106, third data source 108, and/or storage unit 116 may be included within data set processing and visualization tool 101.

In some embodiments, requestor 102a may be a user device associated with an administrator of system 100. In some embodiments, requestor 102b may be a user device associated with an analyst (e.g., a salesperson) of system 100. In some embodiments, requestor 102c may be a user device associated with an approver (e.g., a manager) of system 100. In some embodiments, requestor 102a, requestor 102b, and/or requestor 102c may interact with graphical user interface module 103 by providing one or more inputs to the module. In some embodiments, graphical user interface module may be configured to generate and/or provide one or more instructions for rendering and/or displaying a graphical user interface, receive one or more user inputs from one or more requestors, and/or update rendering and/or display of the graphical user interface in response to the one or more user inputs. In some embodiments, as will be explained further below, each of requestor 102a, requestor 102b, and requestor 102c may be associated with a permission setting to access and/or provide inputs to one or more screens of the graphical user interface. Depending on the type of requestor (e.g., a role of the requestor, permissions levels of the requestor, predefined preferences for a requestor, etc.), different inputs may be provided and/or different screens may be accessed and/or updated. While described with respect to three requestors, including an administrator type of requestor, an analyst type of requestor, and an approver type of requestor, system 100 may include any number of requestors and any type of requestor, each of which may be associated with a permission to access and/or provide inputs to any number of screens associated with the graphical user interface.

In some embodiments, a requestor (e.g., requestor 102a) may initiate data set processing and/or visualization by transmitting one or more inputs to graphical user interface module 103 of tool 101. In some embodiments, inputs received from requestor 102a may indicate (1) instructions to ingest one or more data sets (e.g., via a selection of one or more data sets shown in the interface generated and caused to be displayed by graphical user interface module 103); and/or (2) instructions to configure and/or execute one or more preprocessing operations. For example, requestor 102a may provide a selection of one or more data sets included in first data source 104, one or more data sets included in second data source 106, and/or one or more data sets in third data source 108. In some embodiments, a summary and/or image of at least a portion of the data included in a selected data set may be presented on the interface generated and caused to be displayed by graphical user interface module 103 (e.g., in a table or an image gallery which displays to a user information pertaining to one or more data sets at a time).

First data source 104, second data source 106, and/or third data source 108 may serve as a data source for data set processing and visualization. First data source 104, second data source 106, and third data source 108 may each include one or more suitable computer storage mediums.

In some embodiments, first data source 104 may comprise a first data set that may include information regarding a first set of entities (e.g., SKUs, each of which may be associated with a product group). In some embodiments, the first data set may be organized in a product hierarchy comprising a plurality of product groups, wherein a first product group of the plurality of product groups may be nested within a second product group of the plurality of product groups. For example, the first data set may comprise SKU information organized in one or more product family product groups, one or more product category product groups nested within a product family product group, and/or one or more SKU product groups (each of which is representative of an individual SKU) nested within a product category product group.

In some embodiments, second data source 106 may comprise a second data set that may include information regarding a second set of entities (e.g., geographic areas in which an organization is doing business, each of which may be associated with an additional geographic area). In some embodiments, the second data set may be organized in a geographic area hierarchy comprising a plurality of geographic areas, wherein a first geographic area of the plurality of geographic areas may be nested within a second geographic area of the plurality of geographic areas. For example, the second data set may comprise geographic information organized in one or more regions, one or more countries nested within a region, and/or one or more local municipalities nested within a country.

In some embodiments, third data source 108 may comprise a third data set that may include information regarding a third set of entities (e.g., SKUs, each of which may be associated with a list price, a cost, a product family, and/or a geographic area). In some embodiments, the first data set, the second data set, and/or the third data set may include at least one common attribute (e.g., an SKU of the third data set may be associated with a product family of the first data set, which may in turn be associated with a geographic area associated with the second data set).

In some embodiments, data source 104, data source 106, and/or data source 108 may comprise one or more databases which organize stored data sets. Each database may support data structures such as strings, integers, hashes, tables, arrays, lists, tuples, stacks, queues, sets, bitmaps, trees, graphs, any combination thereof, or the like. In some embodiments, data source 104 is a product hierarchy database, data source 106 is a geographic hierarchy database, and data source 108 is an SKU cost and list price database. In some embodiments, as will be explained below, the databases may be aggregated, thereby creating a more complete, broader (“enriched”) database from which data-driven insights may be gleaned.

In some embodiments, a plurality of product hierarchy databases, geographic hierarchy databases, and/or SKU cost and list price databases may be used to generate an enriched database. Using a plurality of product hierarchy databases, geographic hierarchy databases, and/or SKU cost and list price databases may be advantageous at least to create as complete and broad an enriched database as possible. While FIG. 1 is shown to include three data sources and described with respect to ingesting data from one data set within each data source, system 100 may include any number of data sources used to ingest data from any number of data sets.

In some embodiments, data may be ingested from first data source 104, second data source 106, and/or third data source 108 to data set processing and visualization tool 101. For example, the cloud-based web-application described above may directly connect to and pull data from data source 104, data source 106, and/or data source 108, thus minimizing unnecessary data exposure and maximizing data security. In some embodiments, as discussed above, data may be ingested from a data source in response to one or more user inputs to ingest data from the data source. In some embodiments, data from multiple data sources may be simultaneously ingested. In some embodiments, additionally or alternatively to data source 104, data source 106, and data source 108, data may be ingested directly from a platform (e.g., Salesforce's Customer Relationship Management (CRM) platform and/or Salesforce's Configure, Price, Quote (CPQ) platform) to tool 101 (e.g., via one or more APIs). In some embodiments, the data sets are ingested via one or more pre-built and/or customized integration scripts for importing data sets into tool 101.

Preprocessing module 110 of tool 101 may be configured to initiate data set processing and visualization in accordance with the user request(s) to ingest data. Preprocessing module 110 may be configured to ingest one or more data sets from one or more data sources in accordance with one or more selection inputs, and generate, based on the ingested data sets, one or more preprocessed data sets. For example, in response to a request from requestor 102a to ingest a first data set included in a product hierarchy database comprised within data source 104, preprocessing module 110 may ingest the first data set. In some embodiments, preprocessing module 110 may perform preprocessing operations including one or more of: standardizing a data set (e.g., converting data to a common format to enable processing and analysis), and cleansing a data set (e.g., replacing, modifying, and/or deleting corrupt, incomplete, incorrect, inaccurate, and/or irrelevant entries; fixing structural errors, such as typos or inconsistent naming conventions; and/or filtering unwanted outliers). Standardizing and/or cleansing a data set may be advantageous at least to increase the validity, accuracy, completeness, consistency, and/or uniformity of a data set.

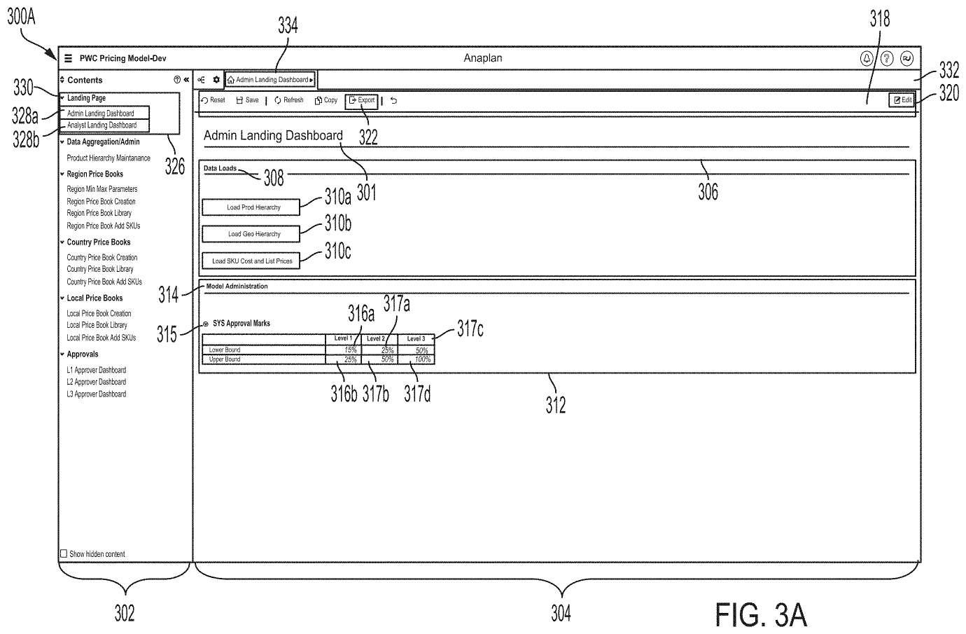

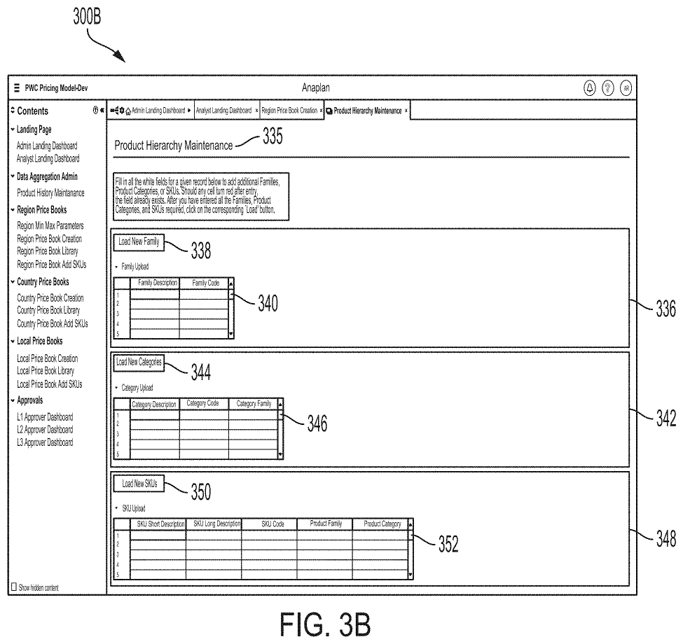

In some embodiments, preprocessing module 110 may additionally be configured to preprocess the data sets by augmenting the data included in the ingested data sets. Preprocessing module 110 may augment the data by (1) associating one or more thresholds with one or more entities included in one or more of the ingested data sets (e.g., associating one or more approval thresholds for adjusting a price data point of an SKU with one or more respective SKUs); and/or (2) adding one or more entities to one or more of the ingested data sets. Preprocessing module 110 may augment the data in accordance with one or more user inputs to augment the data (e.g., one or more user inputs from requestor 102a to the interface generated and displayed by graphical user interface module 103), which will be explained further with respect to FIGS. 3A and 3B. In some embodiments, preprocessing module 110 may be configured to transmit the preprocessed data sets to a graphical user interface (e.g., the interface generated and caused to be displayed by graphical user interface module 103), a data storage medium (e.g., data storage unit 116), and/or processing module 112.

Processing module 112 may be configured to receive the preprocessed data sets and generate, based on the preprocessed data sets, one or more price books. Specifically, processing module 112 may be used to aggregate the preprocessed data sets, thereby generating an aggregated data set.

In some embodiments, the aggregated data set may be organized into one or more price books, each of which includes a consolidated list of information pertaining to one or more SKUs included in the ingested data. One, some, or all SKUs may be associated with a set of attributes including product hierarchy data, geographic hierarchy data, and/or SKU cost and list price data. The aggregated data set may be organized into one or more price books in accordance with one or more user inputs to organize the aggregated data set into one or more price books. For example, processing module 112 may be configured to filter the aggregated data set for a set of SKUs to include in a price book in response to one or more user inputs from requestor 102b via the interface generated and displayed by graphical user interface module 103.

In some embodiments, processing module 112 may be configured to modify one or more of the price books by (1) adjusting an attribute (e.g., a price data point) associated with an SKU in the one or more price books; (2) adding one or more SKUs to the one or more price books; and/or (3) deleting one or more SKUs from the one or more price books. In some embodiments, the processing module may modify one or more of the price books in accordance with one or more user inputs from requestor 102b (e.g., requestor 102b may adjust a price attribute of an SKU via a price book modification input executed via the interface generated and displayed by graphical user interface module 103). In some embodiments, the preprocessing module may additionally or alternatively modify one or more of the price books in accordance with one or more user inputs from requestor 102c. For example, requestor 102c may approve a price book modification via an approval input executed via the interface generated and displayed by graphical user interface module 103. In some embodiments, if the adjusted price of the modified SKU deviates from an acceptable price range for the SKU, system 100 may automatically display the interface to requestor 102c to solicit approval.

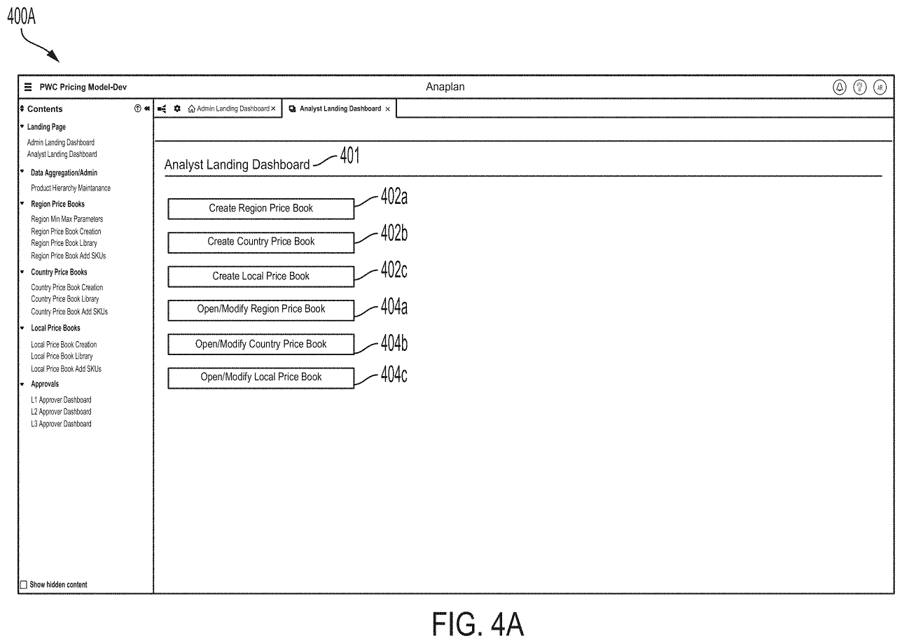

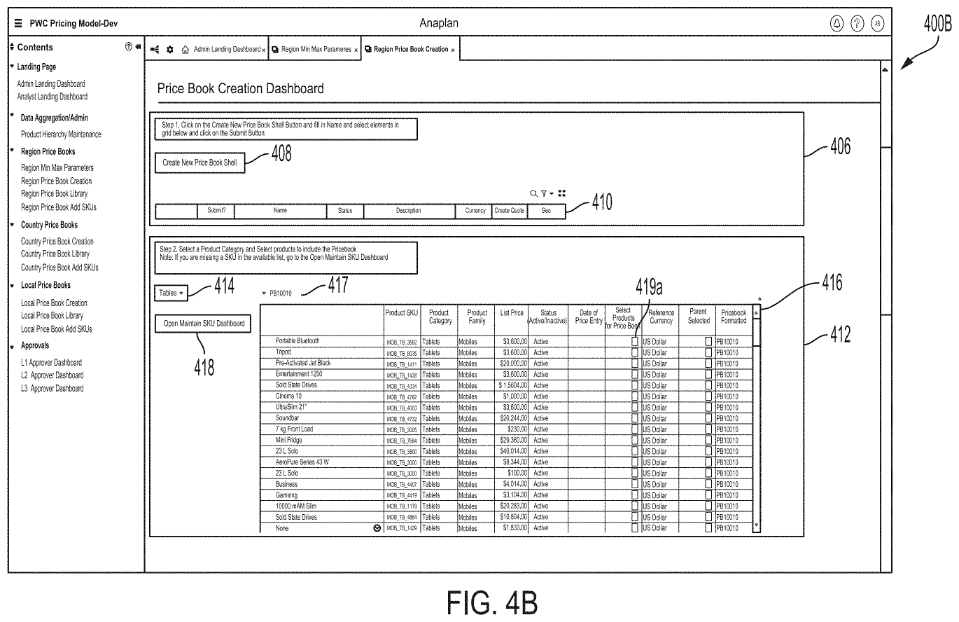

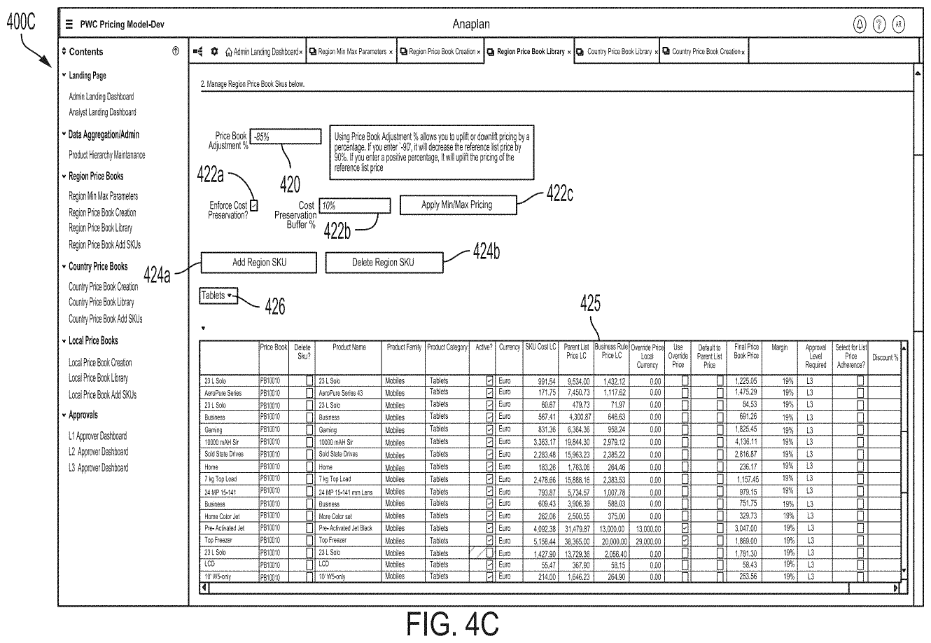

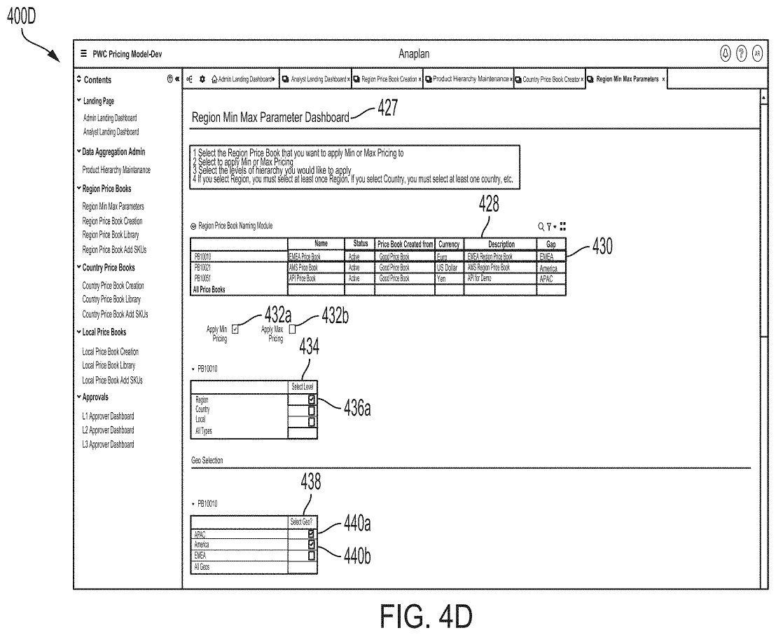

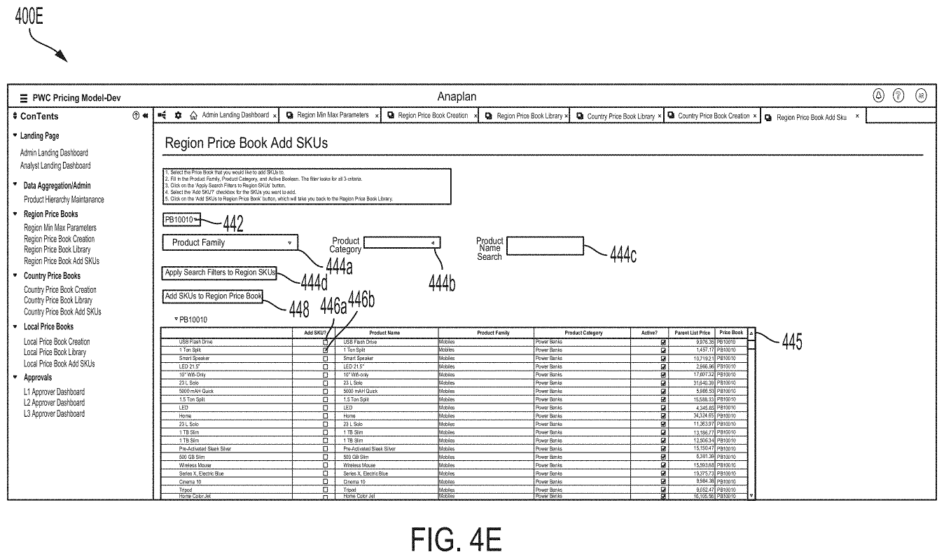

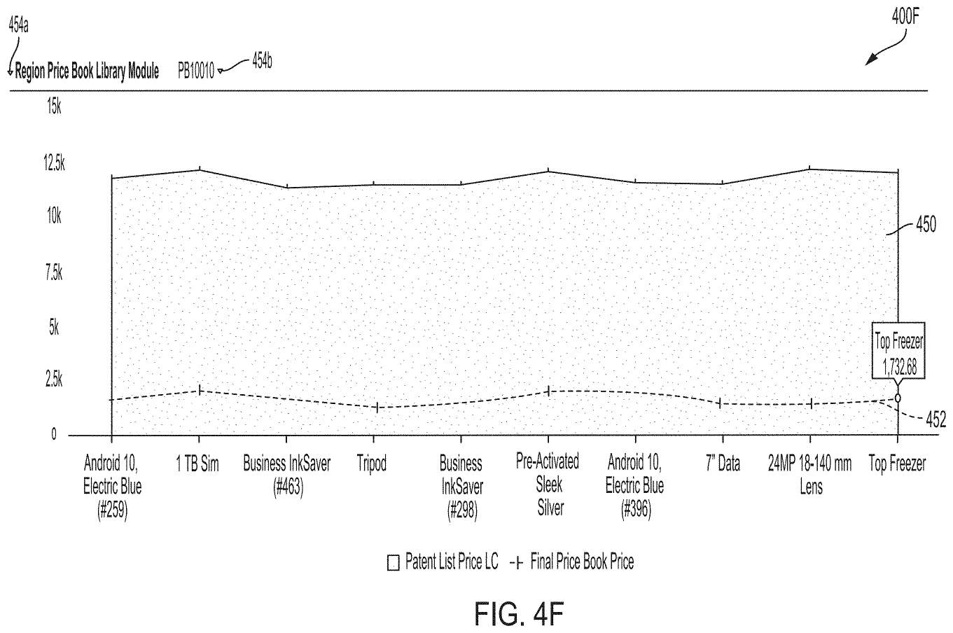

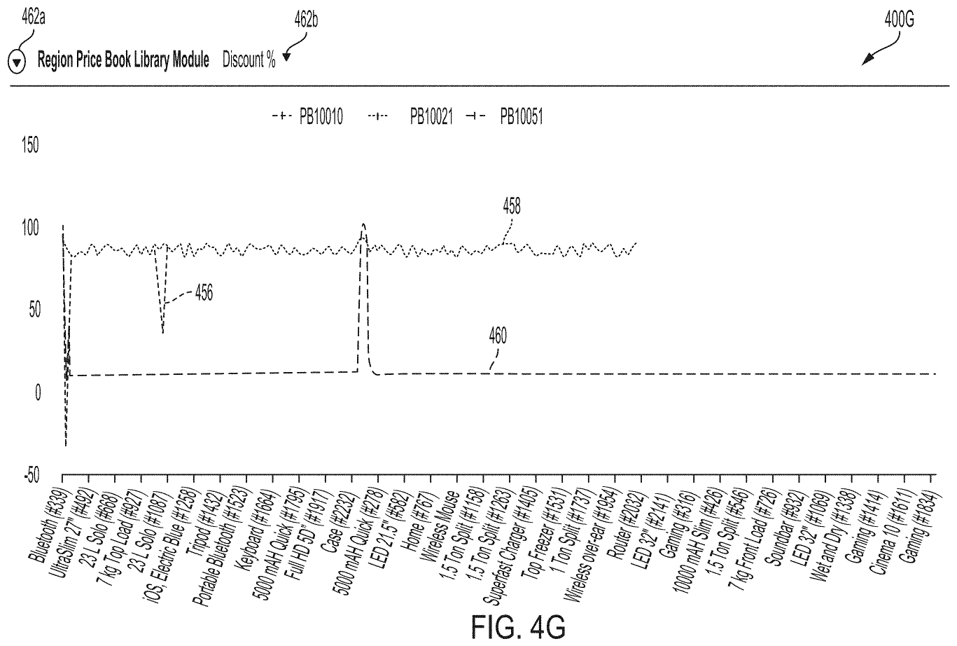

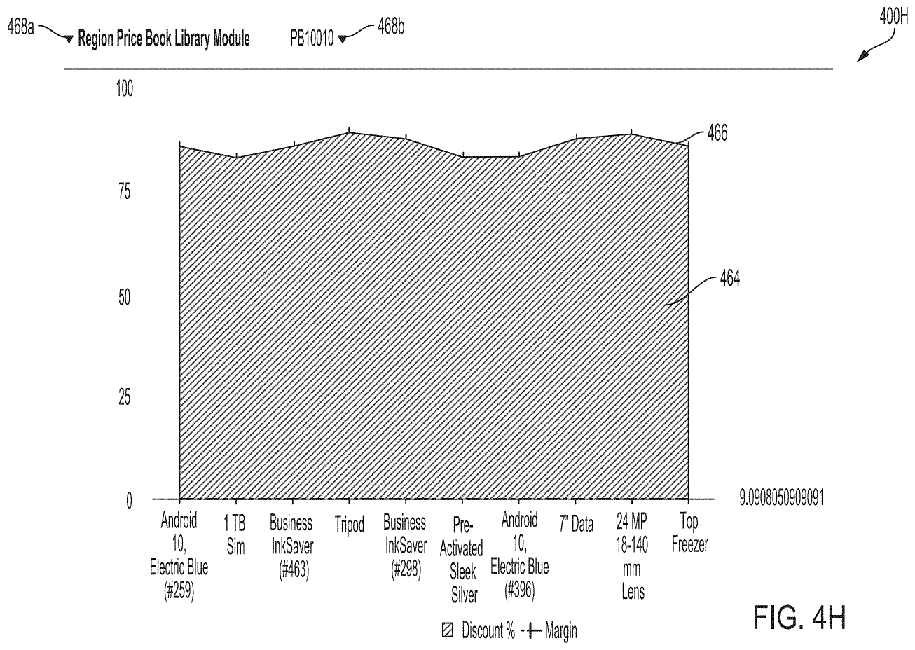

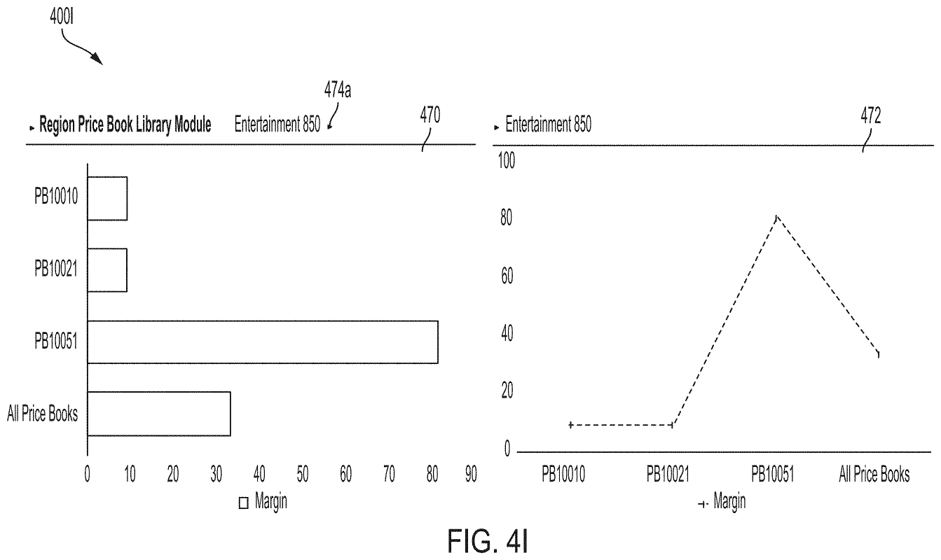

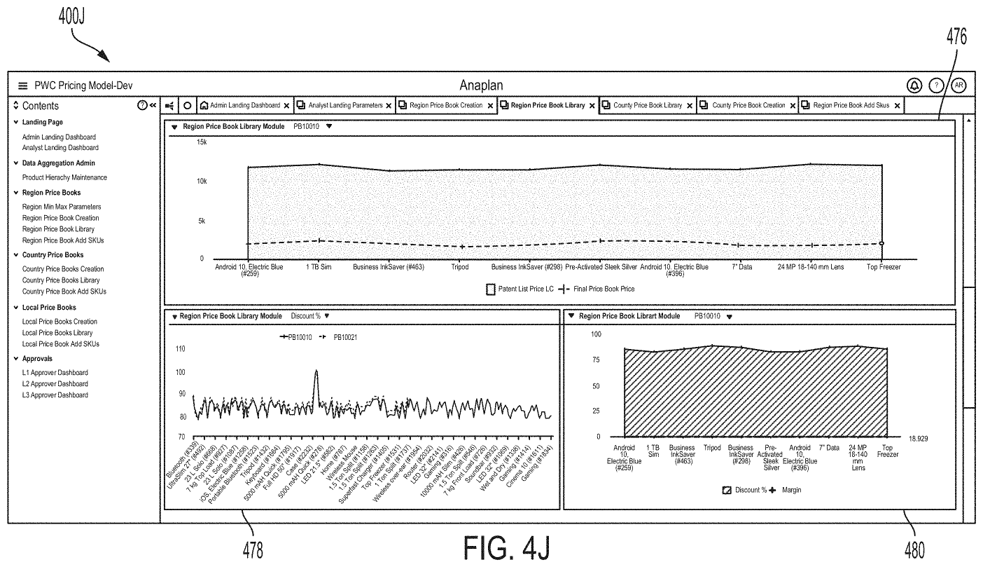

In some embodiments, processing module 112 may be configured to create one or more new price books based on the aggregated data set. In some embodiments, the processing module may create the one or more new price books in accordance with one or more user inputs from requestor 102b (e.g., in accordance with a price book creation input executed via the interface generated and displayed by graphical user interface module 103). In some embodiments, the one or more user inputs may indicate a respective set of SKUs and/or a respective set of attributes for one or more SKUs of the respective set of SKUs to include in a respective price book, which will be explained further with respect to FIGS. 4B, 5A, and 6A.

In some embodiments, processing module 112 may be configured to generate one or more price books based on the aggregated data set via a distributed computation cluster, which may advantageously reduce the computing time needed for a user to generate data insights and/or recommendations. In some embodiments, processing module 112 may be configured to transmit the one or more price books to a graphical user interface (e.g., the interface generated and caused to be displayed by graphical user interface module 103), a data storage medium (e.g., data storage unit 116), and/or visualization module 114.

In some embodiments, visualization module 114 may be configured to receive the one or more price books and generate and display a visualization of data included in the one or more price books. In some embodiments, the visualization may be generated and displayed in accordance with one or visualization inputs to display a subset of attributes for a subset of SKUs included in one or more price books (e.g., via a visualization input executed by requestor 102b via the interface generated and caused to be displayed by graphical user interface module 103).

In some embodiments, the visualization module may interface with one or more connectors (e.g., REST APIs and/or Informatica, MuleSoft, Dell Boomi, SnapLogic) to generate and display the visualization. In some embodiments, the visualization may be displayed on any platform. In some embodiments, the visualization may be platform agnostic by leveraging connectors which are configured to integrate with a wide range of platforms.

In some embodiments, the visualization may be displayed on the same platform (e.g., tool 101) used to enable one or more users to provide one or more inputs to ingest data, manage the ingested data, and/or analyze the ingested data. Displaying the visualization on the same platform used to enable a user to provide one or more inputs to ingest data, to manage the ingested data, and/or to analyze the ingested data may advantageously (1) enable real-time use such that a user may perform multiple analyses and/or test different scenarios (“what-if” testing) without needing to access a separate user interface; (2) simultaneously display the criteria used to initiate data set processing and visualization and the outcome of the data set processing and visualization in the same user interface; and/or (3) maximize ease-of-use, thereby lowering training costs. In some embodiments, the visualization may simultaneously be displayed on a plurality of user devices (e.g., a user device associated with requestor 102b and a user device associated with requestor 102c), such that a plurality of users have access to the data.

In some embodiments, visualization module 114 may be configured to transmit the data to a graphical user interface (e.g., the interface generated and caused to be displayed by graphical user interface module 103) and/or a data storage medium of automated data set processing and visualization system 100 (e.g., data storage unit 116). In some embodiments, storage unit 116 may comprise one or more databases which organize stored data.

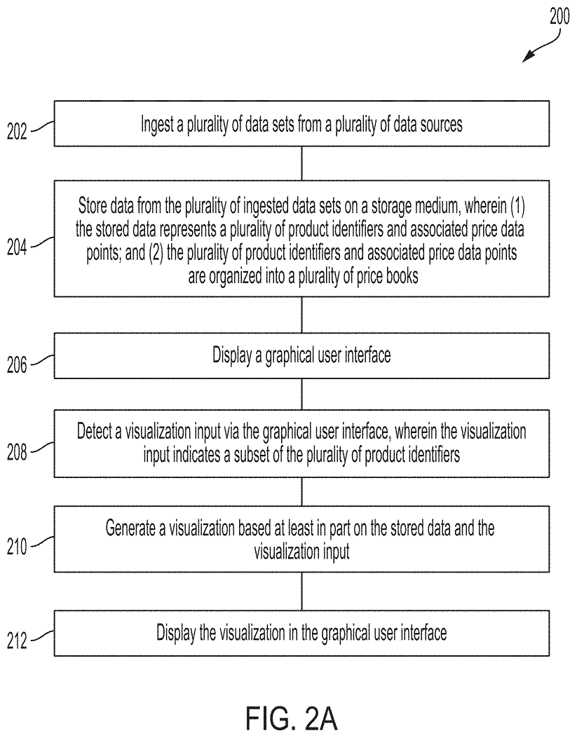

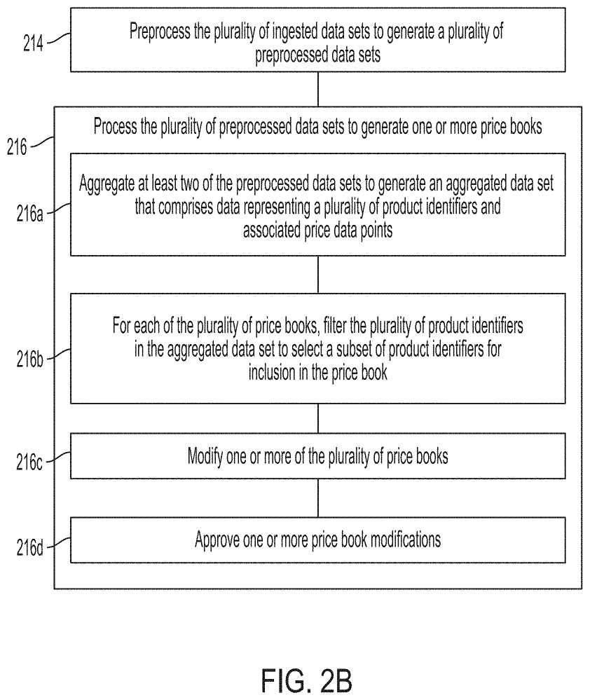

FIGS. 2A-2B depict flowcharts of a method for using an automated data set processing and visualization system according to some embodiments. As shown, FIG. 2A depicts a method by which an automated data set processing and visualization system (e.g., automated data set processing and visualization system 100 of FIG. 1) generates and displays data visualizations. In some embodiments, using an automated data set processing and visualization system may include performing any one or more of the steps of FIG. 2A.

At block 202, in some embodiments, a data set processing and visualization tool (e.g., tool 101 of system 100) may ingest a plurality of data sets from a plurality of data sources. In some embodiments, data set ingestion may occur in accordance with one or more user inputs (e.g., one or more inputs executed by requestor 102a via the graphical user interface generated and caused to be displayed by graphical user interface module 103). Any number of user inputs may be received to ingest the one or more data sets. For example, three user inputs may be received. A first user input may indicate to ingest a first data set (e.g., the product hierarchy data set) from a first data source, a second user input may indicate to ingest a second data set (e.g., the geographic hierarchy data set) from a second data source, and a third user input may indicate to ingest a third data set (e.g., the SKU cost and list price data set) from a third data source. Each user input may be received from a different user of system 100, or all user inputs may be received from one user of system 100. Alternatively, in some embodiments, one user input may be received to ingest the plurality of data sets (e.g., such that the user input simultaneously indicates ingestion of the first, second, and third data sets).

The user input(s) may be received based at least in part on a requestor's desire to ingest data pertaining to a specific set of entities. As described with respect to FIG. 1, the first data set may include information regarding a first set of entities (e.g., product groups); the second data set may include information regarding a second set of entities (e.g., geographic areas); and the third data set may include information regarding a third set of entities (e.g., SKUs). The product hierarchy data set, the geographic hierarchy data set, and/or the SKU cost and list price data set may be ingested in accordance with the one or more user inputs.

At block 204, in some embodiments, data from the plurality of ingested data sets may be stored on a storage medium (e.g., storage unit 116 of FIG. 1). In some embodiments, the stored data may represent a plurality of product identifiers (e.g., SKUs) and associated prices (and/or other associated product characteristics). In some embodiments, the data may be stored in accordance with product hierarchy data that organizes the product SKUs into a plurality of product groups. In some embodiments, the plurality of SKUs may be organized into a plurality of price books. In some embodiments, each of the plurality of price books may be associated with a geographic area.

In some embodiments, generating the stored data described with respect to block 204 may include performing any one or more of the steps of FIG. 2B.

At block 214, in some embodiments, one, some, or all of the ingested data sets may be preprocessed to generate a plurality of preprocessed data sets. Preprocessing the ingested data sets may comprise (1) standardizing and/or cleaning the ingested data sets; (2) associating one or more thresholds with one or more entities included in one or more of the ingested data sets; and/or (3) adding one or more entities to one or more of the ingested data sets.

In some embodiments, standardizing and/or cleansing the ingested data sets may comprise converting data to a common format to enable processing and analysis; replacing, modifying, or deleting corrupt, incomplete, incorrect, inaccurate, or irrelevant entries; fixing structural errors, such as typos or inconsistent naming conventions; and/or filtering unwanted outliers, as described with respect to FIG. 1.

In some embodiments, associating one or more thresholds with one or more entities included in one or more of the ingested data sets may comprise mapping the thresholds to respective entities in accordance with one or more user inputs. For example, a user input may be received to assign one or more approval thresholds to one or more attributes (e.g., a price attribute) associated with one or more entities (e.g., SKUs) included in the ingested data sets. In some embodiments, the user input may indicate that an SKU associated with a price that is discounted between 15% and 25% is associated with an approval level 1. Similarly, additional thresholds may be indicated, such that SKUs associated with other prices are associated with other approval levels.

At block 216, in some embodiments, the preprocessed data sets may be processed to generate one or more price books.

At block 216a, in some embodiments, processing the preprocessed data sets may comprise aggregating at least two of the preprocessed data sets to generate an aggregated data set. In some embodiments, the at least two preprocessed data sets may be aggregated by mapping common attributes included in the data sets, as described with respect to FIG. 1. In some embodiments, the at least two preprocessed data sets may automatically be aggregated. In some embodiments, the at least two preprocessed data sets may be aggregated in response to a user input to aggregate the preprocessed data sets.

In some embodiments, the aggregated data set may comprise a plurality of SKUs, each of which may be associated with a respective set of attributes (e.g., a product group, a geographic area, and/or a list price). In some embodiments, each SKU may be associated with one or more price data points. In some embodiments, one, some, or all SKUs of the aggregated data set may be organized into a plurality of price books, each of which includes data (e.g., price data) representing a respective subset of the plurality of SKUs, based at least in part on the product group data and/or the geographic area data. In some embodiments, each price book of the plurality of price books may indicate, for each respective SKU in the price book, a respective price data point of the one or more price data points for the respective SKU.

At block 216b, in some embodiments, for each price book, processing the preprocessed data sets may comprise filtering the aggregated data set to select a subset of the plurality of SKUs for inclusion in the price book. In some embodiments, the plurality of SKUs may be filtered in accordance with one or more user inputs. In some embodiments, the plurality of SKUs may be filtered by geographic area and/or by product group. For example, a first price book may include SKUs for a geographic region “Americas,” representative of countries in North, Central, and South America, and a second price book may include SKUs for a geographic region “EMEA,” representative of countries in Europe, the Middle East, and Africa. Additionally, a third price book may include SKUs for the geographic region “Americas,” but may include one or more different SKUs associated with the “Americas” region (e.g., SKUs associated with a different product family) compared to the first price book.

Additionally or alternatively, at block 216b, in some embodiments, the data set processing and visualization tool may create one or more new price books based at least in part on one or more price book creation inputs. In some embodiments, a price book creation input may comprise an indication of a set of SKUs to include in a new price book.

In some embodiments, for example to create a new price book for a region, the indication of the set of SKUs for the new price book may comprise an indication of one or more product groups (e.g., one or more product families, product categories, and/or SKUs). In some embodiments, the price book creation input may additionally comprise an indication of a set of attributes for one or more SKUs of the set of SKUs for the new price book. In some embodiments, the new price book may be created based at least in part on the indication of the set of attributes for the one or more SKUs of the set of SKUs for the new price book.

In some embodiments, for example to create a new price book for a country or local municipality, the indication of the set of SKUs for the new price book may comprise an indication of a preexisting price book. The set of SKUs may be a subset of the SKUs included in the preexisting price book. Thus, a user may be able to flexibly and rapidly create a new price such that it includes relevant SKUs for a particular problem to be solved.

At block 216c, in some embodiments, one or more of the plurality of price books may be modified. In some embodiments, a price book may be modified by adding and/or deleting one or more SKUs included in the price book. In some embodiments, one or more of the plurality of price books may be modified to adjust a price associated with an SKU. In some embodiments, a price associated with an individual SKU may be modified, a plurality of SKUs in an indicated price book may be modified, and/or a plurality of SKUs in a plurality of indicated price books may be modified. The one or more price books may be updated in real-time based at least in part on a price book modification input (e.g., via an input from requestor 102b of FIG. 1). In some embodiments, adjusting a price associated with an SKU may comprise (1) manually adjusting a price data point for an SKU to a user-specified price; (2) applying a price book adjustment percentage, wherein applying the price book adjustment percentage comprises modifying respective price data points for a plurality of respective SKUs by an indicated percentage; (3) applying a cost preservation, wherein applying the cost preservation comprises modifying respective price data points for a plurality of respective SKUs such that the price data points are, at minimum, equal to a respective cost to manufacture the SKU; (4) applying a cost preservation buffer, wherein applying the cost preservation buffer comprises modifying respective data points for a plurality of respective SKUs such that the price data points exceed a respective cost to manufacture the SKU by an indicated percentage and/or amount; and/or (5) applying a min/max pricing scheme, wherein applying the min/max pricing scheme comprises modifying respective price data points of respective SKUs such that the price data points fall within a specified min/max envelope. Thus, even if two price books include the same set of SKUs, each could include different price data associated with the set of SKUs. This may enable a user of the automated data set processing and visualization tool to more easily and accurately quantify an impact of a modification (e.g., by comparing the two price books).

At block 216d, in some embodiments, one or more of the price book modifications may be approved. In some embodiments, in response to the one or more price book modification inputs, the data set processing and visualization tool may automatically determine a set of one or more of the plurality of price books for which approval for a modification is required. In some embodiments, the determination may be based at least in part on one or more approval thresholds for adjusting the price data point for an SKU (e.g., the approval thresholds described with respect to block 214). In some embodiments, an indication of the one or more of the plurality of price books for which approval is required may be displayed. In some embodiments, one or more price book modifications may be approved in accordance with one or more user inputs (e.g., via one or more approval inputs from requestor 102c of FIG. 1). Thus, in some embodiments, one or more of the plurality of price books may be modified in accordance with (1) one or more price book modification inputs; and (2) one or more approval inputs.

Turning back to FIG. 2A, at block 206, in some embodiments, a graphical user interface (e.g., the graphical user interface generated and caused to be displayed by graphical user interface module 103) may be displayed. In some embodiments, the interface may comprise a visualization portion and an input portion (e.g., a portion comprising one or more interactive affordances and/or fields configured to accept user inputs).

At block 208, in some embodiments, a visualization input may be detected via the graphical user interface described with respect to block 206. In some embodiments, the visualization input may indicate a subset of the plurality of SKUs. In some embodiments, the indication of the subset of the plurality of SKUs may comprise an indication of one or more of the plurality of price books. In some embodiments, the visualization input may comprise an indication of a subset of attributes in addition to the indication of the plurality of SKUs. For example, a request may be received to display revenue for the ten highest-grossing SKUs in a price book.

At block 210, in some embodiments, a visualization of data included in one or more of the plurality of price books may be generated. In some embodiments, the visualization generation may be based at least in part on the stored data described with respect to block 204 and the visualization input described with respect to block 208. In some embodiments, the visualization may comprise a graph displaying a subset of attributes for a subset of SKUs. In some embodiments, the visualization may simultaneously comprise a plurality of graphs, each of which may display a different subset of attributes and/or SKUs.

At block 212, in some embodiments, the generated visualization may be displayed on an interface (e.g., the interface described with respect to block 206). In some embodiments, the visualization may be displayed in the visualization portion of the interface. In some embodiments, visualization generation and display may occur in real-time, such that (1) visualization generation and display may be catered to the context of a problem to be solved; and (2) a user of an automated data set processing and visualization system may be able to efficiently and effectively make decisions pertaining to the one or more price books.

FIGS. 3A-3B, 4A-4J, 5A-5C, 6A-6C, and 7 show exemplary an exemplary graphical user interface associated with an automated data set processing and visualization system (e.g., automated data set processing and visualization system 100), according to some embodiments.

FIGS. 3A-3B illustrate aspects of an exemplary user interface for allowing a user to ingest and/or preprocess one or more data sets associated with an automated data set processing and visualization system.

As indicated by title 301, screen 300A of the user interface may be a landing page for an administrator (e.g., a data scientist) associated with an automated data set processing and visualization system. The administrator may ingest and/or preprocess one or more data sets via the landing page.

As shown in FIG. 3A, the user interface may include a sidebar display region 302 for managing a plurality of screens associated with the user interface and a main display region 304 for managing data associated with a selected screen of the user interface.

Main display region 304 may include a first region 306 for ingesting one or more data sets. In some embodiments, region 306 may include a data field indicating the content included in the region. In some embodiments, a pre-defined and/or a user-defined text string (e.g., text string 308) may be entered into the data field. Region 306 may additionally include one or more indicators (e.g., indicators 310a-310c, which may be buttons), each of which may be representative of a respective data set. For example, as shown in FIG. 3A, indicator 310a may represent a product hierarchy data set, indicator 310b may represent a geographic hierarchy data set, and indicator 310c may represent an SKU cost and list price data set. In some embodiments, in response to a user selection of an indicator, the corresponding data set may be ingested into the system. In some embodiments, the ingested data set may automatically be standardized and/or cleansed, as explained above with respect to FIG. 2A.

In some embodiments, main display region 304 may include a second region 312 for preprocessing one or more of the ingested data sets by associating one or more thresholds with one or more entities included in one or more of the ingested data sets. In some embodiments, region 312 may include data field(s) indicating the content included in the region. In some embodiments, a pre-defined and/or a user-defined text string (e.g., text string 314 and/or text string 315) may be entered into the data field(s). In some embodiments, region 312 may include a system approval matrix, as indicated by text string 315. Region 312 may include one or more data fields (e.g., data field 316a) which may be filled-in to assign a user-defined threshold that corresponds to an attribute (e.g., a price data point) associated with one or more entities (e.g., SKUs) included in one or more of the ingested data sets. In some embodiments, the threshold may be an approval threshold associated with a discount percentage for an SKU, such that if an SKU is discounted by a certain percentage or amount, managerial approval is required. In some embodiments, in response to a user selection of data field 316a, a menu may be displayed in a third region (e.g., region 318) of main display region 304. In some embodiments, the menu may include a plurality of options for modifying the content included in data field 316a. For example, the menu may include a checkbox (e.g., checkbox 320) for editing a numerical value input into data field 316a and/or a button (e.g., button 322) to export the content included in data field 316a.

In some embodiments, region 314 may include a plurality of data fields that may be filled-in to assign a plurality of thresholds to one or more of the data sets indicated in region 306. In some embodiments, each of the plurality of data fields may enable a user to assign an additional approval threshold that corresponds to the price data point attribute associated with one or more SKUs included in one or more of the ingested data sets.

In some embodiments, as shown in FIG. 3A, the plurality of data fields may be arranged in a table (e.g., the system approval matrix) for ease of organization. In some embodiments, the columns of the approval matrix may indicate approval levels. In some embodiments, an approval level may be associated with one or more managers who have permission to perform an action (e.g., manager(s) who have permission to approve price quotes). While shown to include three approval levels, the approval matrix may include any number of approval levels. In some embodiments, the rows of the approval matrix may indicate upper and lower bounds associated with an approval level. Thus, manager(s) associated with an approval level may be responsible only for SKUs that have discount percentages between the upper and lower bounds. As shown in FIG. 3A, a discount percentage less than 15% may not require approval, a discount percentage between 15% (indicated by data field 316a) and 25% (indicated by data field 316b) may require approval from a manager associated with approval level 1, a discount percentage between 25% (indicated by data field 317a) and 50% (indicated by data field 317b) may require approval from a manager associated with approval level 2, and a discount percentage between 50% (indicated by data field 317c) and 100% (indicated by data field 317d) may require approval from a manager associated with approval level 3. One some, or all of the thresholds may be user-defined. In some embodiments, in response to a user input to assign the thresholds, the thresholds may be applied any time that a price data point is discounted (e.g., by a salesperson quoting a price) by a percentage or amount indicated by the approval levels.

Turning back to sidebar display region 302, the sidebar display region may include one or more indicators, each of which corresponds to a respective screen associated with the user interface. In some embodiments, in response to a selection of an indicator, the corresponding screen may be displayed. One, some, or all of the screens may be associated with a permission setting to access the screen (e.g., as discussed above, screen 300A may be accessible only to an administrator). Thus, a user of automated data set processing and visualization system 100 may be able to rapidly and flexibly change the screen displayed in accordance with the user's permission setting. This may be advantageous at least to enable the user to efficiently and effectively perform multiple analyses, test different scenarios (“what-if” testing), and make data-driven decisions. While only described with respect to FIG. 3A, sidebar display region 302 may be displayed on additional screens associated with the user interface.

In some embodiments, the one or more indicators may be grouped and displayed in one or more sections. For example, as shown in FIG. 3A, the sections may include a “Landing Page” section (section 326), a “Region Price Books” section, a “Country Price Books” section, a “Local Price Books” section, and/or an “Approvals” section. As shown, the “Landing Page” section may include an indicator for an “Admin Landing Dashboard” (indicator 328a) and/or an “Analyst Landing Dashboard” (indicator 328b). In some embodiments, an indicator may be generated automatically by copying the title of a screen as it appears on the interface (e.g., the title of screen 300A is indicated by text string 301, which is subsequently copied and displayed as indicator 328a). Similarly, other sections may include other indicators for respective screens associated with those sections. In some embodiments, the one or more indicators may be grouped into sections automatically. In some embodiments, the one or more indicators may be grouped into sections manually according to user preferences. In some embodiments, one or more of the interfaces associated with a section may be displayed and/or hidden. In some embodiments, one or more of the interfaces associated with a section may be displayed and/or hidden in response to a user input (e.g., indicators 328a and 328b may be displayed and/or hidden in response to a user selection of user affordance 330).

In some embodiments, one or more of the indicators displayed in the sidebar region may additionally or alternatively be displayed in region 332 of main display region 304. In some embodiments, those indicators corresponding to active screens (e.g., those screens that are currently displayed) may be displayed in region 332. For example, an indicator for the active screen “Admin Landing Page” (indicator 334), but not other screens, is displayed in region 332. By displaying indicators for active screens, a user may be able to more quickly and easily select an important screen to view. In some embodiments, in response to a user selection of an indicator displayed in region 332, a corresponding screen may be displayed.

Turning to FIG. 3B, in some embodiments, upon ingesting a data set, a screen may be displayed to enable a user to preprocess the ingested data set by viewing and/or modifying one or more of the entities included in the data set and/or by adding one or more entities to the data set. For example, upon ingesting the product hierarchy data set, the screen shown in FIG. 3B (screen 300B) may be displayed. As indicated by title 335, screen 300B may by a product hierarchy data set maintenance page. In some embodiments, as described above, the product hierarchy data set may include product family, product category, and/or SKU entities.

A first region 336 of the interface may include one or more data fields for viewing, modifying, and/or adding product family entities for the product hierarchy data set. In some embodiments, each product family entity may be associated with attributes including a family description and/or a family code. As shown in FIG. 3B, in some embodiments, the attributes pertaining to product family entities may be displayed in a data table (e.g., table 340), in which each entity is displayed as a row and each attribute is displayed as a column. In some embodiments, a user may select a data field associated with an entity included in data table 340 to modify the content included in the data field. In some embodiments, the user may select the data field to add missing data that was not ingested (e.g., the data field may be blank, and the user may subsequently manually fill in the data field). In some embodiments, the user may add a new product family entity to the product hierarchy data set by filling in each attribute for a row of data table 340. In some embodiments, a data field may automatically turn red if the user enters duplicative information (e.g., if all attributes associated with one entity are the same as all attributes associated with another entity). In some embodiments, once the user is satisfied with the data included in the data table, the user may refresh the product hierarchy data set (e.g., by selecting user affordance 338 to load the new data pertaining to product family entities).

Similarly, a second region 342 of the interface may include one or more data fields for viewing, modifying, and/or adding product category entities for the product hierarchy data set. In some embodiments, each product category entity may be associated with attributes including a category description, a category code, and/or a category family. As shown in FIG. 3B, in some embodiments, the attributes pertaining to product category entities may be displayed in a data table (e.g., table 346), in which each entity is displayed as a row and each attribute is displayed as a column. In some embodiments, a user may select a data field associated with an entity included in data table 346 to modify the content included in the data field. In some embodiments, the user may select the data field to add missing data that was not ingested (e.g., the data field may be blank, and the user may subsequently manually fill in the data field). In some embodiments, the user may add a new product category entity to the product hierarchy data set by filling in each attribute for a row of data table 346. Adding data for product categories entities may be important at least to properly associate product category entities with product family entities. In some embodiments, once the user is satisfied with the data included in the data table, the user may refresh the product hierarchy data set (e.g., by selecting user affordance 344 to load the new data pertaining to product category entities).

Further, a third region 348 of the interface may include one or more data fields for viewing, modifying, and/or adding SKU entities included in the product hierarchy data set. In some embodiments, each SKU entity may be associated with attributes including an SKU short description, and SKU long description, an SKU code, a product family, and/or a product category. As shown in FIG. 3B, in some embodiments, the attributes pertaining to product category entities may be displayed in a data table (e.g., table 352), in which each entity is displayed as a row and each attribute is displayed as a column. In some embodiments, a user may select a data field associated with an entity included in data table 352 to modify the content included in the data field. In some embodiments, the user may select the data field to add missing data that was not ingested (e.g., the data field may be blank, and the user may subsequently manually fill in the data field). In some embodiments, the user may add a new SKU entity to the product hierarchy data set by filling in each attribute for a row of data table 352. Adding data for SKU entities may be important at least to associate SKU entities with product category and/or product family entities. In some embodiments, once the user is satisfied with the data included in the data table, the user may refresh the product hierarchy data set (e.g., by selecting user affordance 350 to load the new data pertaining to SKU entities).

Displaying regions 336, 342, and 348 simultaneously may enable a user to quickly review different types of entities included in the product hierarchy data set. This may be important at least so that the user can ensure proper mapping of SKU entities to produce category and/or product family entities (e.g., so that the user can verify that overlapping attributes associated with data tables 340, 346, and 352 are properly populated in the data tables).

While FIG. 3B has been depicted and described with respect to the product hierarchy data set, a user may similarly view, modify, and/or add entities for the geographic hierarchy data set and/or the SKU cost and list price data set.

In some embodiments, permission to access the screens shown in FIGS. 3A and 3B (interfaces 300A and 300B) may be restricted. For example, permission to access the screens may be restricted to an administrator (e.g., a data scientist). Restricting access to the screens may be advantageous at least to enhance data security and/or data standardization.

In some embodiments, after the data sets have been ingested and preprocessed as explained above, they may be aggregated to generate an aggregated data set. Thus, an aggregated data set, which includes data attributes included in the product hierarchy data set, the geography data set, and the SKU data set, may be generated. In some embodiments, the aggregated data set may be generated by mapping common attributes included in the ingested data sets, as described above.

FIGS. 4A-4J, 5A-5C, and 6A-6C illustrate aspects of an exemplary user interface for enabling a user to process and visualize ingested and preprocessed data sets associated with an automated data set processing and visualization system.

As indicated by title 401, screen 400A may be a landing page for an analyst (e.g., a salesperson) associated with a data set processing and visualization system. The analyst may create, open, and/or modify one or more price books via the landing page.

As described above, each price book may be associated with a geographic area of a plurality of geographic areas (e.g., based on geographic hierarchy data included in the geographic hierarchy data set). In some embodiments, a price book includes SKUs associated with one or more regions, SKUs associated with one or more countries, and/or SKUs associated with one or more local municipalities.

As shown in FIG. 4A, screen 400A may include a plurality of user affordances (e.g., user affordances 402a-c and 404a-c) for creating, opening, and/or modifying one or more price book based on the aggregated data set.

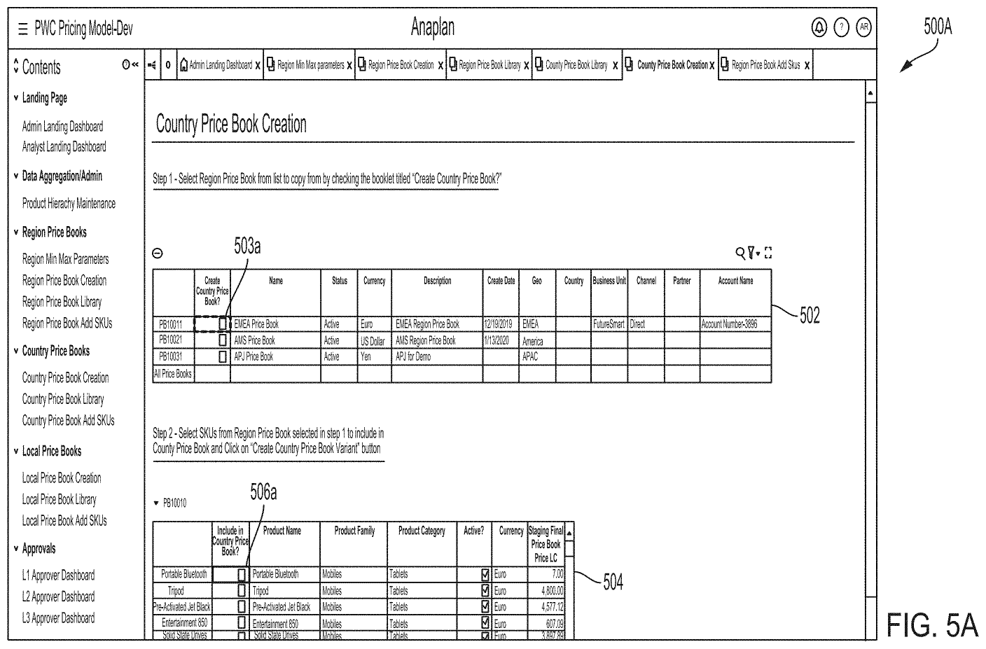

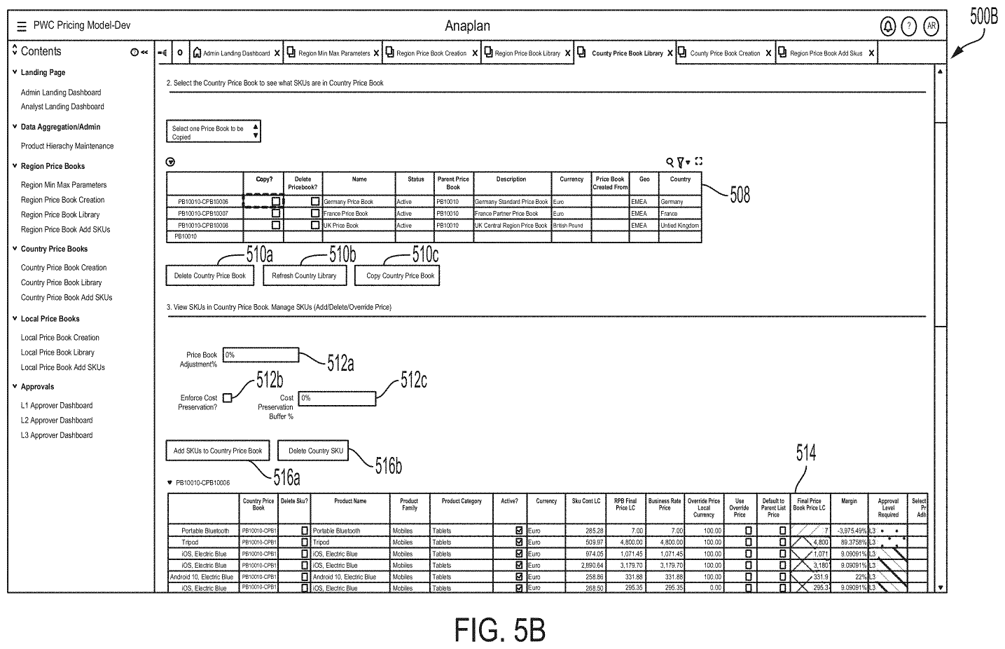

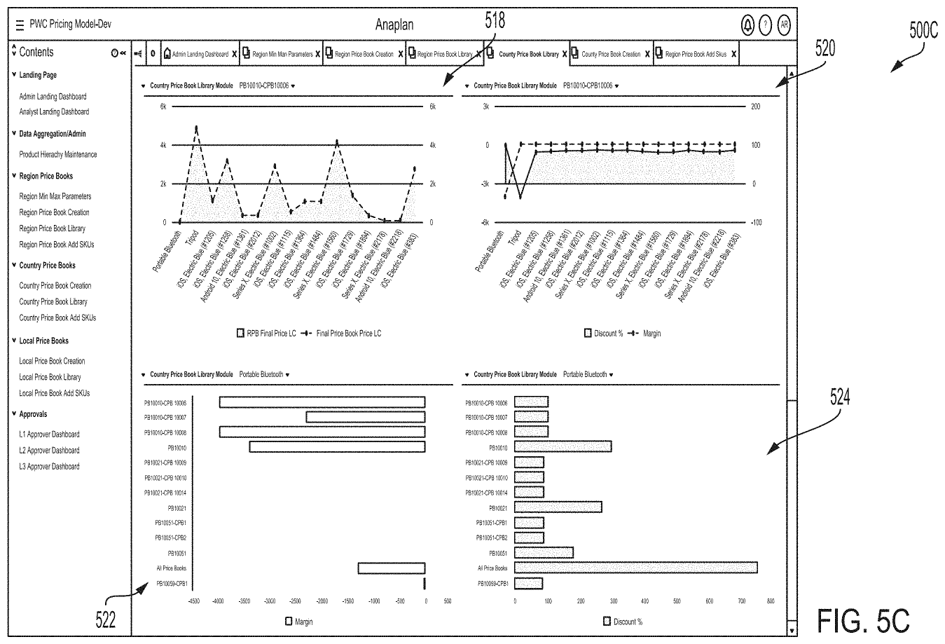

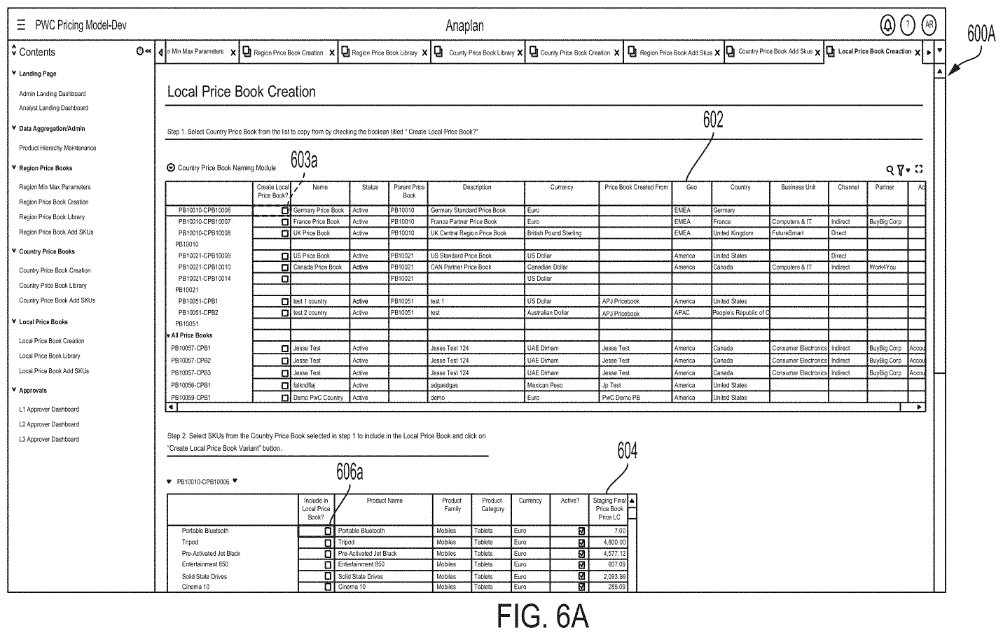

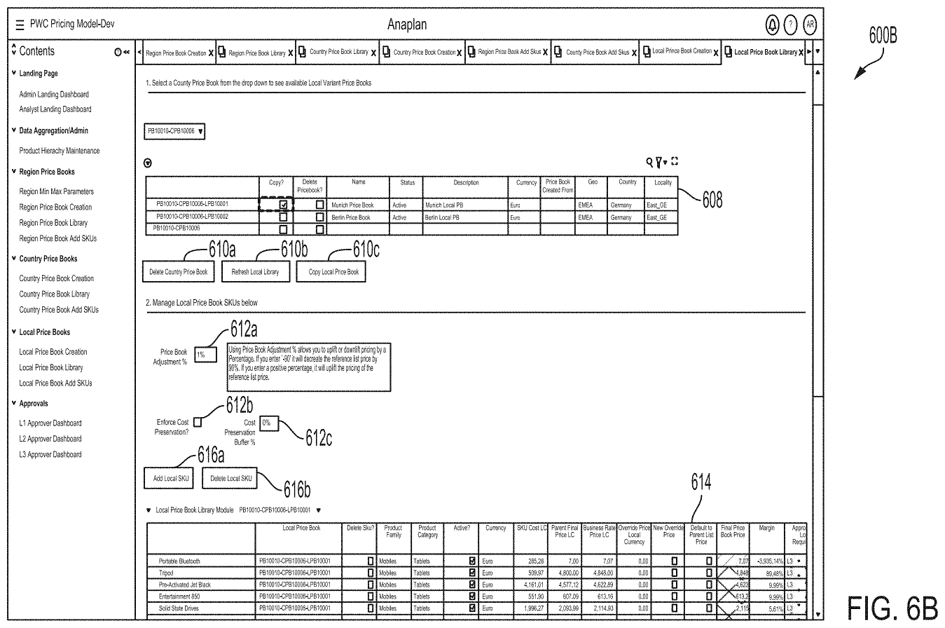

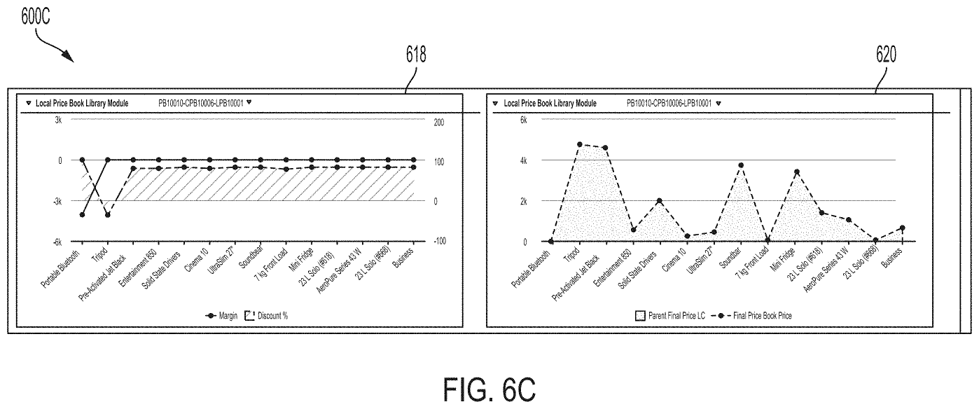

In some embodiments, user affordances 402a-c may be selected to create one or more new price books. User affordance 402a, labeled “Create Region Price Book,” may be selected to create one or more new region price books. In some embodiments, in response to a user selection of user affordance 402a, screen 400B of FIG. 4B may be displayed to create a price book for a region. User affordance 402b, labeled “Create Country Price Book,” may be selected to create one or more new country price books. In some embodiments, in response to a user selection of user affordance 402b, screen 500A of FIG. 5A may be displayed to create a price book for a country. User affordance 402c, labeled “Create Local Price Book,” may be selected to create one or more new local price books. In some embodiments, in response to a user selection of user affordance 402c, screen 600A of FIG. 6A may be displayed to create a price book for a local municipality. While screen 400A is shown to include three user affordances for creating new price books, any number of user affordances for creating new price books may be displayed. Displaying three user affordances may be advantageous at least because the process of creating a new price book may be unique for a region, for a country, and for a local municipality.

In some embodiments, user affordances 404a-c may be selected to view and/or modify one or more preexisting price books. User affordance 404a, labeled “Open/Modify Region Price Book,” may be selected to view and/or modify one or more preexisting region price books. In some embodiments, in response to a user selection of user affordance 404a, screen 400C of FIG. 4C may be displayed. User affordance 404b, labeled “Open/Modify Country Price Book,” may be selected to view and/or modify one or more preexisting country price books. In some embodiments, in response to a user selection of user affordance 404b, screen 500B of FIG. 5B may be displayed. User affordance 404c, labeled “Open/Modify Local Price Book,” may be selected to view and/or modify one or more preexisting local price books. In some embodiments, in response to a user selection of user affordance 404c, screen 600B of FIG. 6B may be displayed. While screen 400A is shown to include three user affordances for opening and/or modifying preexisting price books, any number of user affordances for opening and/or modifying preexisting price books may be displayed.

Turning to FIG. 4B, screen 400B may be displayed to create a new region price book. In some embodiments, screen 400B may include one or more user affordances for creating a new region price book.

In some embodiments, screen 400B may include region 406, in which a user may indicate one or more attributes to include in the new region price book. In some embodiments, the user may select user affordance 408, titled “Create New Price Book Shell,” and in response, select one or more attributes (e.g., attributes “Status,” “Description,” “Currency,” “Create Date,” and/or “Geo” shown in data table 410) to include in the price book. In some embodiments, the attributes may be gleaned from the aggregated data set comprising attributes associated with the product hierarchy, geographic hierarchy, and SKU cost and list price data sets. In some embodiments, the user may additionally name the newly created price book by inserting a text string into a data field of table 410 (e.g., into a data field associated the “Name” column shown in table 410). In some embodiments, the user may select a user affordance (e.g., a checkbox) included in a data field associated with the “Submit?” column shown in table 410 to confirm selection of the one or more attributes to be included in the price book.

In some embodiments, screen 400B may additionally include region 412, in which a user may select one or more SKUs to include in the new region price book. In some embodiments, the user may select user affordance 414 (which may be configured to display a drop-down menu) to select a subset of SKUs included in the aggregated data set to include in the price book. For example, a user may select SKUs associated with one or more product groups (included in the product hierarchy data set) to include in the data list. In some embodiments, in accordance with the user inputs described with respect to data table 410 and user affordance 414, the new region price book may be created for the indicated attributes and the indicated SKUs.

In some embodiments, the created region price book may be displayed to the user in a data table (e.g., data table 416) so that the user may review the data included in the region price book. As shown in FIG. 4B, attributes associated with an SKU of the price book may include: “Product SKU,” “Product Category,” “Product Family,” “List Price,” “Status” (e.g., active or inactive), “Date of Entry,” “Reference Currency,” and/or “Parent Selected?” (e.g., whether a parent price book is selected). In some embodiments, a user may select an SKU displayed to include the SKU in the price book (e.g., the user may select checkbox 419a associated with the column labeled “Select Products for Price Book” to select the “Portable Bluetooth” SKU). In some embodiments, the name of the price book displayed (e.g., “PB10010,” as indicated by indicator 417) may be displayed in association with the data table. In some embodiments, the user may select a user affordance (e.g., a drop-down menu) associated with names of price books to flexibly modify which price book is displayed in region 412. In some embodiments, the user may modify one or more of the SKUs included in the data table (e.g., in response to selection of user affordance 418, labeled “Open Maintain SKU Dashboard”). This may be desirable at least to adjust a price data point associated with an SKU and/or to add one or more important SKUs not included in the price book. In some embodiments, screen 400C of FIG. 4C may be displayed in response to the selection of user affordance 418.

In some embodiments, screen 400C may be a dashboard for opening and/or modifying one or more region price books (which may be stored in and/or displayed as, e.g., part of a price book library). In some embodiments, screen 400C may include a data table (e.g., data table 425) for visualizing data included in the one or more price books. In some embodiments, each row may represent an SKU and each column may represent information associated with the SKU. In some embodiments, screen 400C may include one or more user affordances for modifying one or more SKUs included in a region price book, for adding one or more SKUs to a region price book, and/or for deleting one or more SKUs from a region price book. For example, a user may select one or more user affordances for modifying a price attribute associated with one or more SKUs of the “PB10010” region price book discussed with respect to FIG. 4B. Modifying the price attribute may be advantageous at least to enable a user to compare different pricing scenarios in different price books.

In some embodiments, the user may modify a price attribute associated with an SKU of the region price book by manually adjusting a price data point associated with the SKU. In some embodiments, the price data point may be adjusted to a pre-defined price and/or to a user-defined price. In some embodiments, the price data point may be adjusted to a parent price (which may be indicative of a default price of the SKU in a parent price book). In some embodiments, the price data point may be adjusted to an override price (which may be indicative of a target price at which to sell the SKU). In some embodiments, the parent price and the override price—as well as additional data, such as an SKU cost, an alternative price, a margin, a discount, and/or a required approval level—may be displayed to the user prior to the user adjustment of a price data point associated with an SKU. For example, as shown in data table 425, parent price data may be included in the column labeled “Parent List Price LC”; override price data may be included in the column labeled “Override Price Local Currency”; SKU cost data may be listed in the column labeled “SKU Cost LC”; alternative price data (which may be generated in accordance with one or more of the modification techniques described below) may be included in the column labeled “Business Rule Price LC”; margin data may be included in the column in the column labeled “Margin”; required approval level data (which may be generated in accordance with the thresholds described with respect to FIG. 3A) may be included in the column labeled “Approval Level Required”; and discount data may be included in the column labeled “Discount.” As indicated by several of the column labels, data may be displayed in a local currency associated with a region in which an SKU is sold. Thus, the user may be able to rapidly quantify the impact of the adjustment before making the adjustment.

In some embodiments, manually adjusting a price data point associated with an SKU may comprise selecting a user affordance (e.g., a checkbox). For example, to adjust a price data point to an override price, the user may select a checkbox in the column labeled “Use Override Price” for an SKU. Similarly, to adjust a price data point to a parent price, the user may select a checkbox in the column labeled “Default to Parent List Price” for an SKU. In some embodiments, in response to the manual overriding of the price for an SKU, the required approval level may automatically be modified (e.g., to the appropriate approval level and/or to a higher approval level than would otherwise be required). In some embodiments, one or more data fields of data table 425 may be highlighted to alert a user to outliers in the data. For example, a data field may be highlighted (e.g., in yellow) to indicate that the price for the entity has been manually overridden. Similarly, a data field (e.g., a data field in the column of table 425 labeled “Active?”) may be highlighted (e.g., in red) to indicate that an entity is inactive.

In some embodiments, the user may modify a price attribute associated with each SKU of the region price book by applying a price book adjustment percentage to each SKU. In some embodiments, the user may apply the price book adjustment percentage by inputting a numerical value into data field 420. In some embodiments, the numerical value may be a percentage ranging from −100% to 100%, where a negative value indicates decreasing a price (“downlifting”) and a positive value increasing a price (“uplifting”). In some embodiments, in response to a user input into data field 420, a respective price data point for each SKU of the price book may be modified by downlifting or uplifting the price data point for the SKU by the indicated percentage. Downlifting or uplifting the list price may be important at least to analyze how a corresponding change in price may affect product demand. While the user input to data field 420 has been described with respect to a percentage, the user input may alternatively represent a dollar amount by which to uplift or downlift a respective price data point for a respective SKU.

In some embodiments, the user may additionally or alternatively modify a price attribute associated with one or more SKUs of the region price book by applying a cost preservation to the one or more SKUs. In some embodiments, the user may apply the cost preservation by selecting checkbox 422a. In some embodiments, in response to the user selection of checkbox 422a, respective price data points for one or more SKUs may be modified such that a respective price data point for an SKU is, at minimum, equal to a respective cost to manufacture the SKU. Ensuring that an SKU price is, at minimum, equal to a cost to manufacture the SKU may be advantageous at least to increase the likelihood that a profit may be generated from selling the SKU.

In some embodiments, the user may additionally or alternatively modify a price attribute associated with one or more SKUs of the region price book by applying a cost preservation buffer percentage to the one or more SKUs. In some embodiments, the user may apply the cost preservation buffer percentage by inputting a numerical value into data field 422b. In some embodiments, the numerical value may be a percentage ranging from 1% to 100%. In some embodiments, in response to the user input to data field 422b, respective price data points for one or more SKUs may be modified such that a respective price data point for an SKU, at minimum, exceeds a respective cost to manufacture the SKU by the indicated percentage. While the user input to data field 422b has been described with respect to a percentage, the user input may alternatively represent a dollar amount by which to exceed a cost to manufacture an SKU. Ensuring that an SKU price, at minimum, exceeds a respective cost to manufacture the SKU by an indicated percentage may be advantageous at least to further increase the likelihood that a profit may be generated from selling the SKU (e.g., after accounting for costs not directly related to manufacturing the SKU).

In some embodiments, the user may additionally or alternatively modify a price attribute associated with one or more SKUs of the region price book by applying a min/max pricing scheme to the price book. In some embodiments, the min/max pricing scheme is associated with a minimum pricing threshold and/or a maximum pricing threshold. Thus, in some embodiments, the user may apply the min/max pricing scheme to ensure that a respective price data point for each SKU within the region price book falls within a specified range between a minimum price indicated by the minimum price threshold and a maximum price indicated by the maximum price threshold. In some embodiments, the price threshold(s) may be predefined and/or user-defined. Applying the min/max pricing scheme may be advantageous at least if a contract requires SKU process to fall within the specified range. In some embodiments, the user may apply the min/max pricing scheme to the price book by selecting button 422c. In some embodiments, in response to a user selection of button 422c, screen 400D of FIG. 4D may be displayed.

Turning to FIG. 4D, screen 400D may be displayed to enable the user to apply a min/max pricing scheme to a price book. In some embodiments, the user may be able to apply the min/max pricing scheme for a plurality of price books. Thus, the user may apply the min/max pricing scheme by selecting one or more user affordances to select one or more price books for which to modify SKU price data points. For example, the user may select region price book “PB10010” (labeled 430) from a plurality of region price books displayed in data table 428.

In some embodiments, the user may additionally select one or more user affordances for applying the minimum pricing threshold and/or the maximum pricing threshold to the one or more selected price books. The user may select user affordance 432a to apply the minimum pricing threshold and/or user affordance 432b to apply the maximum pricing threshold.

In some embodiments, the user may additionally select a subset of SKUs associated with the selected price book(s) for which to apply the minimum pricing threshold and/or the maximum pricing threshold. For example, as shown in data table 434, the SKUs included in the price book(s) may be associated with one or more regions, one or more countries, and/or one or more local municipalities. The user may select (e.g., via user affordance 436a) to apply the threshold(s) to a subset of SKUs associated with one or more region areas.

In some embodiments, once the user has selected to apply the threshold(s) to the subset of SKUs associated with one or more region areas, the user may further select a subset of SKUs for which to apply the threshold(s). For example, as shown in data table 438, a first subset of the SKUs associated with the one or more region areas may be associated with an “APAC” region (indicative of Asia-Pacific countries), a second subset of the SKUs associated with the one or more region areas may be associated with the “Americas” region, and a third subset of the SKUs associated with the one or more region areas may be associated with the “EMEA” region. The user may select (e.g., via user affordances 440a and 440b) to apply the threshold(s) to only those SKUs associated with the “APAC” and “Americas” regions.

Thus, the user may flexibly define the SKUs for which to apply the threshold(s). This may be advantageous at least to (1) enhance the quality of analysis (e.g., by enabling a user to filter for SKUs that are important to a particular analysis); and/or (2) reduce unnecessary computing resources that may otherwise be consumed by applying the threshold(s) and/or performing other analyses on all SKUs included in the price book(s). Moreover, in some embodiments, one or more of the user affordances described above (e.g., user affordances 432a, 432b, 436a, 440a, and/or 440b) may be checkboxes, which may increase the simplicity of user interaction with the interface. In some embodiments, once the one or more thresholds have been defined, screen 400C of FIG. 4C may once again be displayed.

Turning back to FIG. 4C, after the user has completed modifying a price attribute associated with an SKU, a final price for the SKU may be displayed to the user. In some embodiments, the final price for the SKU may represent a price for which to sell the SKU. In some embodiments, the final price may be displayed in data table 425 in the column labeled “Final Price Book Price.” In some embodiments, the margin, the discount, and/or the required approval level associated with the SKU may be adjusted based at least in part of the final price for the SKU.

In some embodiments, a user may further modify a region price book by adding one or more SKUs to the region price book. Adding an SKU to a region price book may be important at least to include all important SKUs in the region price book. In some embodiments, the user may add the one or more SKUs based at least in part on selecting a user affordance (e.g., button 424a) to add an SKU to a price book (e.g., price book “PB10010”). In some embodiments, in response to a user selection of button 424a, screen 400E of FIG. 4E may be displayed.

Turning to FIG. 4E, in some embodiments, screen 400E may be displayed to enable the user to add one or more SKUs to a region price book. In some embodiments, screen 400E may include one or more user affordances for adding one or more SKUs to the region price book. In some embodiments, the user may select a user affordance (e.g., user affordance 442, labeled “PB10010”) to select the appropriate price book for which to add the one or SKUs. In some embodiments, user affordance 442 may be a drop-down menu of price books. In some embodiments, the user may then select one or more user affordances to generate a set of SKUs that may be added to the selected price book. For example, as shown in FIG. 4E, the user may select user affordance 444a (which may be a drop-down menu for selecting one or more product families), user affordance 444b (which may be a drop-down menu for selecting one or more product categories), user affordance 444c (which may be a data field for entering an SKU name), and/or user affordance 444d (which may be a button for applying the criteria indicated by the user in response to selection of user affordances 444a, 444b, and/or 444c). The set of SKUs which may be added to the selected region price book may be displayed to the user (e.g., in a data table, such as data table 445). In some embodiments, the user may then select a user affordance for adding an SKU to the region price book. As shown in FIG. 4E, for each SKU included in the data table, a respective user affordance in a data field associated with an “Add SKU?” column may be selected (e.g., such that user affordance 446a may be selected to add the SKU “USB Flash Drive” to the price book and/or user affordance 446b may be selected to add the SKU “1 Ton Split” to the price book. In some embodiments, the user affordance may be a checkbox. In some embodiments, once the user has selected all SKUs they wish to add to the price book, the user may select a user affordance (e.g., user affordance 448, which may be a button) to add the SKUs to the region price book. In some embodiments, in response to selection of user affordance 448, screen 400C of FIG. 4C may once again be displayed.

Turning back to FIG. 4C, in some embodiments, a user may further modify a region price book by deleting one or more SKUs from the region price book. Deleting an SKU from a region price book may be important at least to reduce the complexity of analyzing a region price book (e.g., by reducing the amount of time and/or resources that may be required to analyze a region price book). In some embodiments, the user may delete the one or more SKUs based at least in part on selecting a user affordance (e.g., button 424b) to delete an SKU from a price book (e.g., price book “PB 10010”). In some embodiments, in response to a user selection of button 424b, an additional user affordance may be displayed to delete one or more SKUs included in the price book. For example, a column of data table 425 (e.g., the column of table 425 labeled “Delete SKU?”) may comprise a checkbox for each SKU, and the user may select a checkbox corresponding to an SKU they would like to delete from the region price book.

In some embodiments, data pertaining to one or more SKUs included in one or more region price books may be visualized in one or more screens of the user interface. A user may be able to flexibly select one or more SKUs and/or one or more attributes associated with the selected SKUs for which to visualize data.

As shown in screen 400F of FIG. 4F, a graph may be displayed, and the displayed graph may include a plurality of attributes for a plurality of SKUs included in a region price book. For example, parent price data and final price data corresponding to the attributes “Parent List Price LC” and “Final Price Book Price,” respectively, may be displayed in a graph shown on screen 400F for SKUs included in region price book “PB10010.” Moreover, the plurality of SKUs included in screen 400F may be selected based at least part on a revenue ranking (e.g., so that attributes for the 5, 10, 15, or 20 SKUs associated with the most revenue are shown). A user may be able to rapidly and flexibly modify which SKUs are shown (e.g., via user affordance 454a and/or user affordance 454b, which may be selected to view SKUs for a different price book). The parent price data and the final price data for the SKUs may be overlaid for ease of comparison. For example, as shown in screen 400F, the parent price data may be shown in area graph 450, and the final price data may be shown in line graph 452 overlaid on area graph 450. Thus, a user may be able to rapidly identify significant deviations between a parent price and a final price for an SKU in a region price book. The user may define new price books to take corrective pricing actions.

Further, as shown in screen 400G of FIG. 4G, a graph may be displayed, and the displayed graph may include an attribute for a plurality of SKUs included in a plurality of region price books. For example, discount percentage data corresponding to the attribute “Discount Percentage” may be shown for a plurality of SKUs included in the price book “PB10010,” the price book “PB10021,” and the price book “PB10051.” In some embodiments, data for the plurality of region price books may be overlaid for ease of comparison. For example, as shown in screen 400G, line graph 456 representing discount percentage data for the region price book “PB10010,” line graph 458 representing discount percentage data for the region price book “PB10021,” and line graph 460 representing discount percentage data for the region price book “PB10051” may be overlaid. Overlaying the data may be beneficial at least because the different price books may include one or more common SKUs, or may even include the same set of SKUs, with the only change being a discount percentage applied to a price data point associated with one or more SKUs. Thus, simultaneously displaying the discount percentage for the different price books may enable a user to quickly determine an appropriate pricing strategy. In some embodiments, the user may be able to rapidly and flexibly modify which SKUs are shown (e.g., via user affordance 462a). In some embodiments, the user may be able to rapidly and flexibly modify which attribute is shown (e.g., via user affordance 462b, which may be a drop-down menu including an option to display the discount percentage data shown in FIG. 4G and an option to display a margin data not shown in FIG. 4G).

In some embodiments, as shown in screen 400H of FIG. 4H, instead of choosing whether to display discount percentage data or margin data for SKUs included in a plurality of region price books, the user may display a graph that includes both discount percentage data and margin data for SKUs included in a region price book. The discount percentage data and the margin data may be overlaid on the graph. For example, as shown in screen 4H, area graph 464 may represent discount percentage data and line graph 466 may represent corresponding margin data. Simultaneously displaying the discount percentage data and the margin data may be advantageous at least to enable a user to quickly and accurately quantify the impact discount percentage has on margin for the SKUs. In some embodiments, the user may be able to rapidly and flexibly modify which SKUs are shown (e.g., via user affordance 468a and/or user affordance 468b, which may be selected to view SKUs for a different price book).

In some embodiments, as shown in screen 400I of FIG. 4I, one or more graphs may be displayed to enable a user to compare an attribute for an SKU included in a plurality of region price books. For example, as shown in screen 400I, margin data is displayed for an SKU (SKU “Entertainment 850”) included in a plurality of price books. In some embodiments, the one or more graphs may include bar graphs, line graphs, a combination thereof, or the like. Screen 400I includes a bar graph in region 470 and a line graph in region 472. In some embodiments, the one or more graphs may include a representation of margin data for the SKU in each of a plurality of price books and/or a representation of average margin data for the SKU (with the average margin data based on an average of respective margin data points associated with the SKU for all price books in which the SKU is included). By comparing multiple price books for an SKU, the user may be able to easily and accurately identify outlier price books for the SKU. In some embodiments, the user may be able to rapidly and flexibly modify which SKU is shown (e.g., via user affordance 474a, which may be selected to view a different SKU).

In some embodiments, one or more of the graphs discussed above with respect to FIGS. 4F-4I may be simultaneously displayed. For example, as shown in screen 400J of FIG. 4J, a graph displaying a comparison between parent price data and final price data for a plurality of SKUs included in a region price book may be shown in region 476, a graph displaying discount percentage data for a plurality of SKUs included in a plurality of region price books may be shown in region 478, and a graph displaying discount percentage data and margin data for a plurality of SKUs included in a region price book may be shown in region 480. Simultaneously displaying the graphs may enable a user to more conveniently and accurately evaluate pricing at multiple levels of granularity (e.g., at both an SKU level and a region price book level). In some embodiments, the location of the graphs relative to each other on screen 400J may be adjusted based at least in part on user preferences.

While interfaces 4B-4J have been shown with respect to processing and visualizing region price books, country price books and/or local price books may alternatively or additionally be processed and visualized, as discussed with respect to FIG. 4A.

For example, screen 500A of FIG. 5A may be displayed to create a new country price book. In some embodiments, screen 500A may include one or more user affordances for creating a new country price book.

In some embodiments, a user may create a new country price book by indicating a set of SKUs included in a preexisting region price book to include in the new country price book. For example, the user may select the preexisting region price book “PB 10010” shown in FIG. 5A and discussed above. In some embodiments, the user may select the region price book (e.g., via selecting user affordance 503a, which may be a checkbox) from a plurality of region price books shown in data table 502. Each price book shown in table 502 may be displayed in association with one or more attributes of the price book (e.g., a price book description and/or geographic area data) to help the user easily distinguish the price books.

In some embodiments, after selecting the region price book, the user may select a subset of SKUs included in the region price book to include in the new country price book. In some embodiments, the user may filter the SKUs included in the region price book by geographic area and/or product group. For example, the user may select SKUs associated with a country. In some embodiments, after filtering the SKUs to select SKUs associated with a country, data pertaining to the SKUs may be displayed (e.g., in data table 504). Moreover, in some embodiments, the user may select a subset of the displayed SKUs to include in the new country price book. In some embodiments, the user may select a respective user affordance displayed in data table 504 corresponding to each SKU the user would like to include in the new country price book. For example, the user may select user affordance 506a, which may be a checkbox, to include the entity “Portable Bluetooth” in the new country price book. In some embodiments, once the user is satisfied with the SKUs selected, the user may select a user affordance (e.g., a button, not shown in FIG. 5A) to create the new country price book.

In some embodiments, the user may view and/or modify one or more country price books via a dashboard, such as the dashboard shown in FIG. 5B. The country price book dashboard shown in screen 500B of FIG. 5B may be very similar to the region price book dashboard shown and described with respect to FIG. 4C. For example, a user may select a country price book from a plurality of country price books shown in data table 508. As shown in table 508, each country price book may be associated with one or more attributes including: “Name,” “Status,” “Description,” “Price Book Created From” (which may refer to a region price book from which the country price book was created), “Geo,” and/or “Country.” Thus, an SKU of a country price book may be associated with more attributes compared to an SKU of a region price book, which may allow for more detailed analyses. Upon selecting the country price book, data associated with the country price book may be displayed in data table 514. In some embodiments, additionally or alternatively, upon selecting the country price book, the user may delete the price book (e.g., via user affordance 510a), refresh the data displayed in data table 508 and/or data table 514 (e.g., via user affordance 510b), and/or copy the price book (e.g., via user affordance 510c).

In some embodiments, upon viewing the country price book, the user may modify the country price book. In some embodiments, the user may modify the country price book by modifying one or more respective price data points associated with one or more SKUs included in the country price book. In some embodiments, the user may modify a price data point for an SKU by applying a price book adjustment percentage (e.g., via user affordance 512a), applying a cost preservation (e.g., via user affordance 512b), and/or applying a cost preservation buffer (e.g., via user affordance 512c). Moreover, in some embodiments, additionally or alternatively, upon viewing the country price book, the user may modify the country price book by adding one or more SKUs to the price book (e.g., via user affordance 516a) and/or deleting one or more SKUs from the price book (e.g., via user affordance 516b).

In some embodiments, data pertaining to one or more SKUs included in one or more country price books may be visualized in one or more screens of the user interface. For example, as shown in screen 500C of FIG. 5C, parent price data and final price data associated with the attributes “RPB Final Price LC” and “Business Rule Price,” respectively, may be displayed (e.g., in region 518) for a plurality of SKUs included in country price book “PB 10010-CPB10006”; discount percentage data and margin data associated with the attributes “Discount %” and “Margin,” respectively, may be displayed (e.g., in region 520) for a plurality of SKUs included in country price book “PB 10010-CPB10006”; margin data associated with the attribute “Margin” may be displayed (e.g., in region 522) for an SKU (e.g., SKU “Portable Bluetooth”) included in a plurality of country price books; and discount percentage data associated with the attribute “Discount %” may be displayed (e.g., in region 524) for an SKU (e.g., SKU “Portable Bluetooth”) included in a plurality of country price books.

Similarly, screen 600A of FIG. 6A may be displayed to create a new local price book. In some embodiments, screen 600A may include one or more user affordances for creating a new local price book.

In some embodiments, a user may create a new local price book by indicating a set of SKUs included in a preexisting country price book to include in the new local price book. For example, the user may select the preexisting country price book “PB10010-CPB10006” shown in FIG. 6A and discussed above. In some embodiments, the user may select the country price book (e.g., via selecting user affordance 604a, which may be a checkbox) from a plurality of country price books shown in data table 602. In some embodiments, the plurality of country price books may be grouped by region, as shown in data table 602. Each price book shown in table 602 may be displayed in association with one or more attributes of the price book (e.g., a price book description and/or geographic area data) to help the user easily distinguish the price books.

In some embodiments, after selecting the country price book, the user may select a subset of SKUs included in the country price book to include in the new local price book. In some embodiments, the user may filter the SKUs included in the country price book by geographic area and/or product group. For example, the user may select SKUs associated with a local municipality. In some embodiments, after filtering the SKUs to select SKUs associated with a local municipality, data pertaining to the SKUs may be displayed (e.g., in data table 604). Moreover, in some embodiments, the user may select a subset of the displayed SKUs to include in the new local price book. In some embodiments, the user may select a respective user affordance displayed in data table 604 corresponding to each SKU the user would like to include in the new local price book. For example, the user may select user affordance 606a, which may be a checkbox, to include the entity “Portable Bluetooth” in the new local price book. In some embodiments, once the user is satisfied with the SKUs selected, the user may select a user affordance (e.g., a button, not shown in FIG. 6A) to create the new local price book.

In some embodiments, the user may view and/or modify one or more local price books via a dashboard, such as the dashboard shown in FIG. 6B. The local price book dashboard shown in screen 600B of FIG. 6B may be very similar to the region price book dashboard shown and described with respect to FIG. 4C and/or the country price book dashboard shown and described with respect to FIG. 5B. For example, a user may select a local price book from a plurality of local price books shown in data table 608. As shown in table 608, each local price book may be associated with one or more attributes including: “Name,” “Status,” “Description,” “Currency,” “Price Book Created From,” “Geo,” “Country,” and/or “Locality.” Thus, an SKU of a local price book may be associated with more attributes compared to an entity of a country price book or a region price book, which may allow for more detailed analyses. Upon selecting the local price book, data associated with the local price book may be displayed in data table 614. In some embodiments, additionally or alternatively, upon selecting the local price book, the user may delete the price book (e.g., via user affordance 610a), refresh the data displayed in data table 608 and/or data table 614 (e.g., via user affordance 610b), and/or copy the price book (e.g., via user affordance 610c).

In some embodiments, upon viewing the local price book, the user may modify the local price book. In some embodiments, the user may modify the local price book by modifying one or more respective price data points associated with one or more SKUs included in the local price book. In some embodiments, the user may modify a price data point for an SKU by applying a price book adjustment percentage (e.g., via user affordance 612a), applying a cost preservation (e.g., via user affordance 612b), and/or applying a cost preservation buffer (e.g., via user affordance 612c). Moreover, in some embodiments, additionally or alternatively, upon viewing the local price book, the user may modify the local price book by adding one or more SKUs to the price book (e.g., via user affordance 616a) and/or deleting one or more SKUs from the price book (e.g., via user affordance 616b).

In some embodiments, data pertaining to one or more SKUs included in one or more local price books may be visualized in one or more screens of the user interface. For example, as shown in interface 600C of FIG. 6C, margin data and discount percentage data associated with the attributes “Margin” and “Discount %,” respectively, may be displayed (e.g., in region 618) for a plurality of SKUs included in local price book “PB 10010-CPB10006-LPB10001”; and parent price data and final price data associated with the attributes “Parent Final Price LC” and “Final Price Book Price,” respectively, may be displayed (e.g., in region 620) for a plurality of entities included in local price book “PB 10010-CPB10006-LPB10001.”

In some embodiments, one or more of the visualizations discussed with respect to FIGS. 4F-4J, 5C, and 6C may be simultaneously displayed. Simultaneously displaying the visualizations may enable a user to more conveniently and accurately evaluate pricing at multiple levels of granularity (e.g., at an SKU level, at a local price book level, at a country price book level, and at a region price book level).

In some embodiments, permission to access the screens shown in FIGS. 4A-4J, 5A-5C, and 6A-6C may be restricted. For example, permission to access the interfaces may be restricted to an analyst (e.g., a salesperson). Restricting access to the screens may be advantageous at least to enhance data security and/or to restrict which users may view and/or make price book modifications.

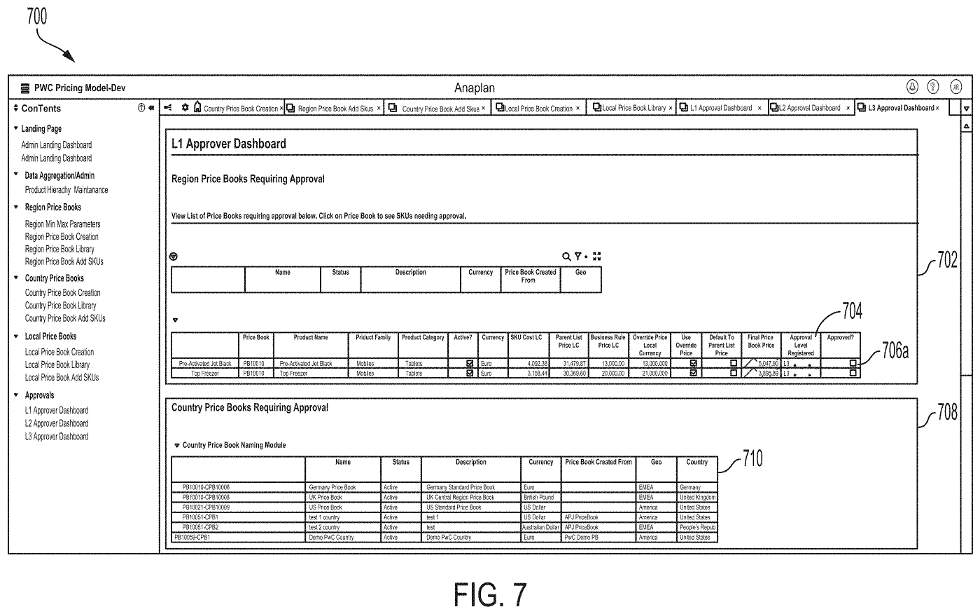

In some embodiments, one or more SKUs included in one or more price books may require approval. For example, an analyst (e.g., a salesperson) may require approval from an approver (e.g., a manager). An approver may need to approve a price adjustment made before an SKU can be sold for a reduced price. In some embodiments, an approver may view the approval dashboard shown in screen 700 of FIG. 7. In some embodiments, an approver associated with a different approval level may view a different approval dashboard. Thus, access to an approval dashboard may be restricted to those approvers who have permission to access the approval dashboard. In some embodiments, an approver may simultaneously view all price books (e.g., region price books, country price books, and/or local price books) that require the approver's approval. Thus, the approval dashboard may serve as a means for the approver to quickly identify those price books for which their approval is needed. The approver may subsequently open the corresponding price books to view the SKU(s) for which approval is needed.

As shown in FIG. 7, price books associated with region price books, country price books, and/or local price books may be displayed grouped together in a respective data table. For example, region price books are shown in data table 704 of region 702, while country price books are shown in data table 710 of region 708. In some embodiments, an approver may select a user affordance to indicate that an SKU associated with a price book indicated as requiring approval has been approved. For example, the approver may select user affordance 706a, which may be a checkbox, to indicate that SKU “Pre-Activated Jet Black” associated with region price book “PB10010” has been approved. In some embodiments, in response to the indication that the SKU has been approved, an approval status for the SKU may automatically be updated, such that the SKU is no longer indicated as requiring approval. The update in approval status may help the approver keep track of which SKUs they have reviewed. Additionally, in some embodiments, the update in approval status may be transmitted in real-time to an analyst associated with the data set processing and visualization system (e.g., so that the analyst is alerted that he or she may sell the SKU).

While the disclosure has been described with respect to region price books country price books, and local price books, the systems and methods described herein may similarly be applied for any data set that includes organized data. Similarly, while the disclosure has been described with respect to price books that catalogue price data for SKUs, the same principles may be used for organized data sets cataloguing any characteristic data for any entities.

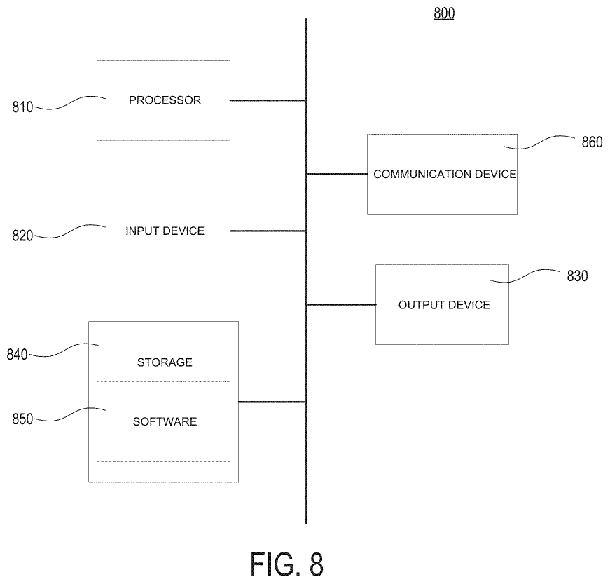

FIG. 8 illustrates an example of a computer, according to some embodiments. Computer 800 can be a component of an automated data set enrichment and analysis system according to the systems and methods described above, such as system 100 of FIG. 1, or can include the entire system itself. In some embodiments, computer 800 may execute a method for managing list prices by ingesting data from one or more data sources, processing the ingested data to generate one or more price books, and displaying visualizations of data included in the one or more price books.

Computer 800 can be a host computer connected to a network. Computer 800 can be a client computer or a server. As shown in FIG. 8, computer 800 can be any suitable type of microprocessor-based device, such as a personal computer, workstation, server, or handheld computing device, such as a phone or tablet. The computer can include, for example, one or more of processor 810, input device 820, output device 830, storage 840, and communication device 860. Input device 820 and output device 830 can correspond to those described above and can either be connectable or integrated with the computer.

Input device 820 can be any suitable device that provides input, such as a touch screen or monitor, keyboard, mouse, or voice-recognition device. Output device 830 can be any suitable device that provides an output, such as a touch screen, monitor, printer, disk drive, or speaker.

Storage 840 can be any suitable device that provides storage, such as an electrical, magnetic, or optical memory, including a random access memory (RAM), cache, hard drive, CD-ROM drive, tape drive, or removable storage disk. Communication device 860 can include any suitable device capable of transmitting and receiving signals over a network, such as a network interface chip or card. The components of the computer can be connected in any suitable manner, such as via a physical bus or wirelessly. Storage 840 can be a non-transitory computer-readable storage medium comprising one or more programs, which, when executed by one or more processors, such as processor 810, cause the one or more processors to execute methods described herein.

Software 850, which can be stored in storage 840 and executed by processor 810, can include, for example, the programming that embodies the functionality of the present disclosure (e.g., as embodied in the systems, computers, servers, and/or devices as described above). In some embodiments, software 850 can include a combination of servers such as application servers and database servers.

Software 850 can also be stored and/or transported within any computer-readable storage medium for use by or in connection with an instruction execution system, apparatus, or device, such as those described above, that can fetch and execute instructions associated with the software from the instruction execution system, apparatus, or device. In the context of this disclosure, a computer-readable storage medium can be any medium, such as storage 840, that can contain or store programming for use by or in connection with an instruction execution system, apparatus, or device.

Software 850 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 800 can implement any operating system suitable for operating on the network. Software 850 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Unless defined otherwise, all terms of art, notations and other technical and scientific terms or terminology used herein are intended to have the same meaning as is commonly understood by one of ordinary skill in the art to which the claimed subject matter pertains. In some cases, terms with commonly understood meanings are defined herein for clarity and/or for ready reference, and the inclusion of such definitions herein should not necessarily be construed to represent a substantial difference over what is generally understood in the art.

As used herein, the singular forms “a,” “an,” and “the” are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

This application discloses several numerical ranges in the text and figures. The numerical ranges disclosed inherently support any range or value within the disclosed numerical ranges, including the endpoints, even though a precise range limitation is not stated verbatim in the specification because this disclosure can be practiced throughout the disclosed numerical ranges.

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims.

1. A system for visualizing price-book data, the system comprising:
a database storing data representing a plurality of product identifiers and associated price data points for respective product identifiers of the plurality of product identifiers, wherein:
the plurality of product identifiers and associated price data points are ingested from a plurality of sources;
the plurality of product identifiers are stored in accordance with product hierarchy data that organizes the product identifiers into a plurality of product groups, wherein a first product group of the plurality of product groups is nested within a second product group of the plurality of product groups; and
the plurality of product identifiers are organized into a plurality of price books, wherein each price book of the plurality of price books is associated with a respective geographic area of a plurality of geographic areas, wherein a first geographic area of the plurality of geographic areas is nested within a second geographic area of the plurality of geographic areas;
one or more processors; and
a memory storing one or more programs, the one or more programs configured to be executed by the one or more processors to cause the system to:
cause display of a graphical user interface comprising a visualization portion and an input portion;
detect a visualization input executed via the input portion of the graphical user interface, wherein the visualization input comprises an indication of a subset of the plurality of product identifiers, wherein the indication of the subset of the plurality of product identifiers comprises an indication of one or more of the price books;
generate a visualization based at least in part on the data and the visualization input; and
cause display of the visualization in the visualization portion.

2. The system of claim 1, wherein:
the data representing the plurality of product identifiers is associated with one or more price data points for each product identifier of the plurality of product identifiers; and
each price book of the plurality of price books indicates, for each respective product identifier in the price book, a respective price data point of the one or more price data points for the respective product identifier.

3. The system of claim 1, wherein the one or more programs are further configured to cause the system to:
receive raw data comprising product hierarchy data, geographic hierarchy data, and raw pricing data; and
process the raw data to generate the plurality of price books.

4. The system of claim 3, wherein:
the product hierarchy data is received from a product hierarchy data source, the geographic hierarchy data is received from a geographic hierarchy data source, and the raw pricing data is received from a pricing data source; and
processing the raw data comprises:
aggregating the product hierarchy data, the geographic hierarchy data, and the raw pricing data to generate the data representing a plurality of product identifiers and associated price data points; and
for each of the plurality of price books, filtering the plurality of product identifiers included in the data representing a plurality of product identifiers to select a subset of the plurality of product identifiers for inclusion in the price book.

5. The system of claim 1, wherein the one or more programs are further configured to cause the system to:
receive a price-book modification input executed via the input portion of the graphical user interface; and
in response to receiving the price-book modification input, modify one or more of the plurality of price books, wherein modifying one or more of the plurality of price books comprises adjusting a price data point for a product identifier in the one or more price books.

6. The system of claim 5, wherein modifying the one or more of the plurality of price books comprises manually adjusting a price data point for the product identifier to a user-specified price.

7. The system of claim 5, wherein modifying the one or more of the plurality of price books comprises simultaneously modifying a plurality of price data points for a plurality of respective product identifiers in an indicated price book of the one or more price books, wherein modification comprises one or more modifications selected from the group of:
applying a price book adjustment percentage, wherein applying the price book adjustment percentage comprises modifying respective price data points for a plurality of respective product identifiers by an indicated percentage;
applying a cost preservation, wherein applying the cost preservation comprises modifying respective price data points for a plurality of respective product identifiers such that the price data points are, at minimum, equal to a respective cost to manufacture the product identifier;
applying a cost preservation buffer, wherein applying the cost preservation buffer comprises modifying respective data points for a plurality of respective product identifiers such that the price data points exceed a respective cost to manufacture the product identifier by an indicated percentage; and
applying a min/max pricing scheme, wherein applying the min/max pricing scheme comprises modifying respective price data points of respective product identifiers such that the price data points fall within a specified min/max envelope.

8. The system of claim 5, wherein modifying the one or more of the plurality of price books comprises simultaneously modifying one or more price data points for one or more respective product identifiers across multiple price books, wherein the modification input comprises an indication of the multiple price books comprising an indication of a geographic area.

9. The system of claim 5, wherein the one or more programs are further configured to:
in response to receiving the price-book modification input:
determine a set of one or more of the plurality of price books for which approval for the modification input is required, wherein the determination is based at least in part on one or more approval thresholds for adjusting the price data point for the product identifier; and
cause display of an indication of the one or more of the plurality of price books for which approval is required.

10. The system of claim 1, wherein the one or more programs are further configured to cause the system to:
receive a price-book creation input executed via the input portion of the graphical user interface, wherein the price-book creation input comprises an indication of a set of product identifiers for a new price book; and
in response to receiving the price-book creation input, create the new price book in the data based at least in part on the indication of the set of product identifiers.

11. The system of claim 10, wherein the indication of the set of product identifiers for the new price book comprises an indication of one or more product groups of the plurality of product groups.

12. The system of claim 10, wherein:
the price-book creation input comprises an indication of a set of attributes for one or more product identifiers of the set of product identifiers for the new price book, and
creating the new price book in the data is based at least in part on the indication of the set of attributes for the one or more product identifiers of the set of product identifiers for the new price book.

13. The system of claim 10, wherein the indication of the set of product identifiers for the new price book comprises an indication of a preexisting price book, wherein the set of product identifiers is a subset of product identifiers from the preexisting price book.

14. The system of claim 1, wherein:
each product identifier of the plurality of product identifiers is stored in association with a respective set of attributes;
the visualization input comprises an indication of a subset of attributes in addition to the indication of the subset of the plurality of product identifiers; and
the visualization comprises a graph displaying the subset of attributes for the subset of product identifiers.

15. The system of claim 14, wherein the visualization simultaneously comprises a plurality of graphs, wherein a first graph of the plurality of graphs displays a first subset of attributes for a first subset of product identifiers, and wherein a second graph of the plurality of graphs displays a second subset of attributes for a second subset of product identifiers.

16. A method for visualizing price-book data, the method performed at a system comprising one or more processors and a database storing data representing a plurality of product identifiers and associated price data points for respective product identifiers of the plurality of product identifiers, wherein:
the plurality of product identifiers and associated price data points are ingested from a plurality of sources;
the plurality of product identifiers are stored in accordance with product hierarchy data that organizes the product identifiers into a plurality of product groups, wherein a first product group of the plurality of product groups is nested within a second product group of the plurality of product groups; and
the plurality of product identifiers are organized into a plurality of price books, wherein each price book of the plurality of price books is associated with a respective geographic area of a plurality of geographic areas, wherein a first geographic area of the plurality of geographic areas is nested within a second geographic area of the plurality of geographic areas;
the method comprising:
causing display of a graphical user interface comprising a visualization portion and an input portion;
detecting a visualization input executed via the input portion of the graphical user interface, wherein the visualization input comprises an indication of a subset of the plurality of product identifiers, wherein the indication of the subset of the plurality of product identifiers comprises an indication of one or more of the price books;
generating a visualization based at least in part on the data and the visualization input; and
causing display of the visualization in the visualization portion.

17. A non-transitory computer-readable storage medium for visualizing price-book data, the non-transitory computer-readable storage medium storing instructions configured to be executed by one or more processors of a system comprising a database storing data representing a plurality of product identifiers and associated price data points for respective product identifiers of the plurality of product identifiers, wherein:
the plurality of product identifiers and associated price data points are ingested from a plurality of sources;
the plurality of product identifiers are stored in accordance with product hierarchy data that organizes the product identifiers into a plurality of product groups, wherein a first product group of the plurality of product groups is nested within a second product group of the plurality of product groups; and
the plurality of product identifiers are organized into a plurality of price books, wherein each price book of the plurality of price books is associated with a respective geographic area of a plurality of geographic areas, wherein a first geographic area of the plurality of geographic areas is nested within a second geographic area of the plurality of geographic areas;
wherein execution of the instructions by the one or more processors causes the system to:
cause display of a graphical user interface comprising a visualization portion and an input portion;
detect a visualization input executed via the input portion of the graphical user interface, wherein the visualization input comprises an indication of a subset of the plurality of product identifiers, wherein the indication of the subset of the plurality of product identifiers comprises an indication of one or more of the price books;
generate a visualization based at least in part on the data and the visualization input; and
cause display of the visualization in the visualization portion.
